(19) United States
(12) Patent Application Publication
(10) Pub. No.: US 2026/0154730 A1
(43) Pub. Date: Jun. 4, 2026

(54) MOBILE BODY CONTROL METHOD, MOBILE BODY, AND COMPUTER PROGRAM PRODUCT

(71) Applicant: Panasonic Intellectual Property Management Co., Ltd., Osaka (JP)

(72) Inventor: Shunsuke KUHARA, Osaka Fu (JP)

(73) Assignee: Panasonic Intellectual Property Management Co., Ltd., Osaka (JP)

(21) Appl. No.: 19/460,997

(22) Filed: Jan. 27, 2026

Related U.S. Application Data
(63) Continuation of application No. PCT/JP2024/005867, filed on Feb. 19, 2024.

(30) Foreign Application Priority Data
Aug. 3, 2023 (JP) 2023-127256

(51) Int. Cl. G06Q 30/0601; G05D 1/689

(52) U.S. Cl. CPC G06Q 30/0639; G05D 1/689

(57) ABSTRACT

A mobile body control method is executed by a computer configured to control a mobile body configured to autonomously move and sell a subject. The mobile body control method includes: specifying a first stop position for stopping the mobile body; stopping the mobile body at the first stop position; executing a selling operation related to selling of the subject to a first user when stopping at the first stop position; determining whether to continue stopping at the first stop position based on situation information about the mobile body at an end of the selling operation; and performing control to continue stopping at the first stop position when determining to continue stopping.

### CROSS-REFERENCE TO RELATED APPLICATIONS

This application is a continuation of International Application No. PCT/JP2024/005867, filed on February 19, 2024 which claims the benefit of priority of the prior Japanese Patent Application No. 2023-127256, filed on August 3, 2023, the entire contents of which are incorporated herein by reference.

### FIELD

An embodiment described herein relates to a mobile body control method, a mobile body, and a computer program product.

### BACKGROUND

There is known a mobile body that autonomously moves, stops due to a calling operation or the like by a user, and performs the operation of selling a subject such as a product or a service for the user. For example, in a case where a predetermined movement of a person is detected during traveling, a system that stops a vehicle in the vicinity of the person and provides a service to the user is disclosed.

However, in the related art, when the operation of selling the subject to the user is ended, the movement of the mobile body is resumed without determining the stop continuation. For this reason, sales opportunities to other users present around the stop position may be lost, and the sales efficiency may deteriorate.

A related technology is described in JP 7095757 B.

### SUMMARY

A mobile body control method according to an embodiment is executed by a computer configured to control a mobile body configured to autonomously move and sell a subject. The mobile body control method includes: specifying a first stop position for stopping the mobile body; stopping the mobile body at the first stop position; executing a selling operation related to selling of the subject to a first user when stopping at the first stop position; determining whether to continue stopping at the first stop position based on situation information about the mobile body at an end of the selling operation; and performing control to continue stopping at the first stop position when determining to continue stopping.

### BRIEF DESCRIPTION OF THE DRAWINGS

FIG. 1 is an explanatory diagram illustrating an example of a mobile body control system according to an embodiment;

FIG. 2 is a functional block diagram of an example of a mobile body control system;

FIG. 3A is a schematic diagram of an example of a data configuration of mobile body management information;

FIG. 3B is a schematic diagram of an example of a data configuration of product management information;

FIG. 4 is a schematic diagram of an example of a data configuration of product management information;

FIG. 5 is an explanatory diagram of an example of a scene in which purchase intention of a second user is detected during autonomous movement of a mobile body toward a first stop position;

FIG. 6 is a flowchart illustrating an example of a flow of information processing executed by a control unit of a mobile body according to the embodiment; and

FIG. 7 is a hardware configuration diagram of an example of an information processing device, an information processing terminal, and a mobile body.

### DESCRIPTION OF EMBODIMENTS

Hereinafter, embodiments of a mobile body control method, a mobile body, and a computer program product will be described in detail with reference to the accompanying drawings.

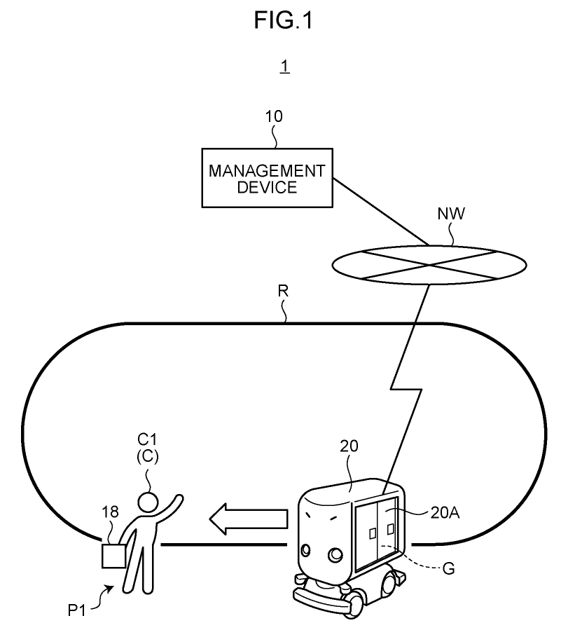

FIG. 1 is an explanatory diagram illustrating an example of a mobile body control system 1 according to the present embodiment.

The mobile body control system 1 includes a management device 10, an information processing terminal 18, and a mobile body 20. The management device 10, the information processing terminal 18, and the mobile body 20 are communicably connected via a network NW or the like.

The management device 10 is an information processing device that manages the mobile body 20. FIG. 1 illustrates a mode in which the mobile body control system 1 includes one mobile body 20 as an example. However, the mobile body control system 1 may include a plurality of mobile bodies 20. In the present embodiment, a description will be given assuming that the mobile body control system 1 includes a plurality of mobile bodies 20.

The information processing terminal 18 is an information processing device used by a user C. The information processing terminal 18 is, for example, a smartphone, a tablet terminal, or the like. In the present embodiment, a mode in which the information processing terminal 18 is a smartphone will be described as an example.

The mobile body 20 is a mobile object that autonomously moves and sells a subject. The mobile body 20 is, for example, a vehicle that autonomously moves, a robot that has a moving function and autonomously moves, or the like. An autonomously moving vehicle may be referred to as an autonomous driving vehicle. In the present embodiment, a mode in which the mobile body 20 autonomously moves along a preset route R will be described as an example. Note that the route on which the mobile body 20 moves is not limited to the predetermined route R.

The subject is a product or a service to be sold to the user C. In the present embodiment, a mode in which the subject is a product G will be described as an example. The user C is a user who uses the subject. Specifically, for example, the user C is a user who purchases the product G loaded on the mobile body 20.

The mobile body 20 is provided with a product storage unit 20A and the like. The product storage unit 20A is a component that holds or supports the product G loaded on the mobile body 20. In the present embodiment, the mobile body 20 autonomously moves along a route R in a state where the product G is loaded in the product storage unit 20A, and executes an operation or the like related to selling of the product G to the user C whose purchase intention has been detected (to be described in detail later).

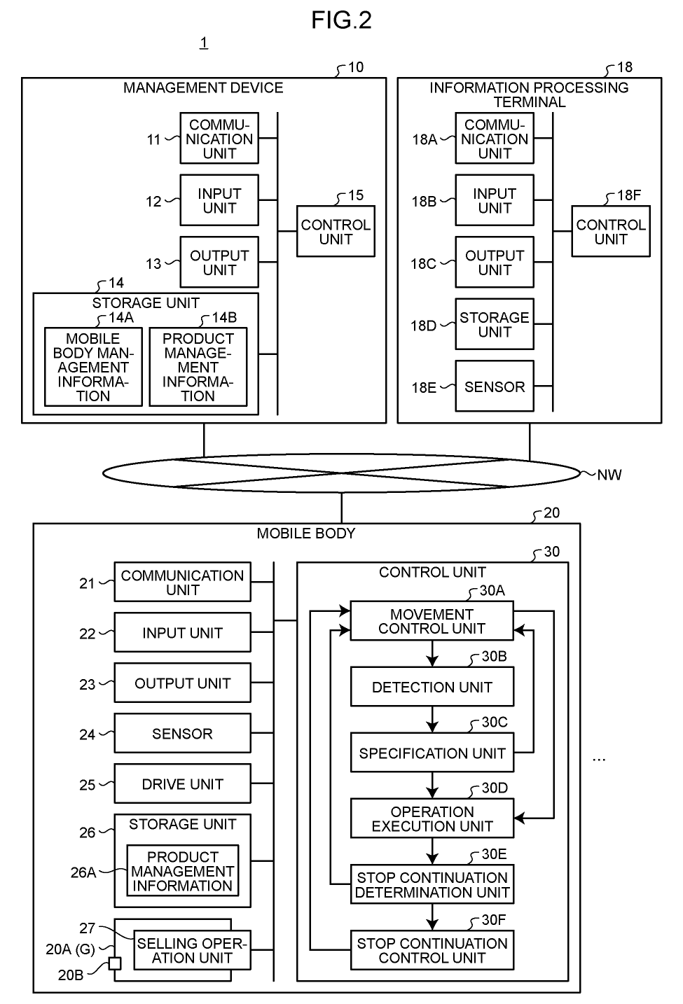

FIG. 2 is a functional block diagram of an example of the mobile body control system 1. The mobile body control system 1 includes a management device 10, an information processing terminal 18, and a mobile body 20.

The management device 10 includes a communication unit 11, an input unit 12, an output unit 13, a storage unit 14, and a control unit 15. The communication unit 11, the input unit 12, the output unit 13, the storage unit 14, and the control unit 15 are communicably connected via a bus or the like.

The communication unit 11 is a communication interface that communicates with the mobile body 20, the information processing terminal 18, and the like via the network NW and the like. The input unit 12 receives various operations by the user. The input unit 12 is, for example, a pointing device such as a keyboard and a mouse, a microphone, or the like. The output unit 13 outputs various types of information. The output unit 13 is a display that displays various types of information, a speaker that outputs various types of sound, or the like. Note that the input unit 12 and the output unit 13 may be integrally configured as a touch panel. Furthermore, the input unit 12 and the output unit 13 may be configured separately from the management device 10. In this case, the input unit 12 and the output unit 13 may be communicably connected to the management device 10.

The storage unit 14 stores various pieces of data. The storage unit 14 is, for example, a semiconductor memory element such as a random access memory (RAM) and a flash memory, a hard disk, an optical disk, or the like. Note that the storage unit 14 may be a storage device provided outside the management device 10. Furthermore, the storage unit 14 may be a storage medium that downloads and stores or temporarily stores programs and various types of information via a local area network (LAN), the Internet, or the like.

In the present embodiment, the storage unit 14 stores mobile body management information 14A and product management information 14B.

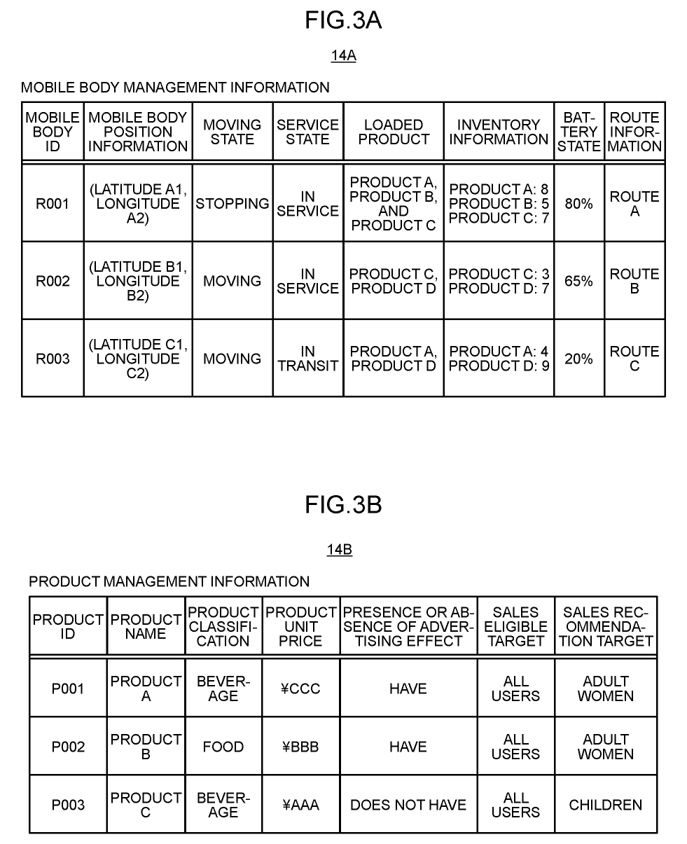

FIG. 3A is a schematic diagram of an example of a data configuration of the mobile body management information 14A.

The mobile body management information 14A is information for managing each of the plurality of mobile bodies 20 included in the mobile body control system 1. Specifically, the mobile body management information 14A is, for example, information in which a mobile body identifier (ID), mobile body position information, a moving state, a service state, a disposed product, a battery state, and route information are associated with each other.

The mobile body ID is identification information about the mobile body 20. The mobile body position information is information indicating the current position of the mobile body 20 identified by the corresponding mobile body ID. The mobile body position information is represented by, for example, latitude and longitude in the real space. The moving state represents a current moving state of the mobile body 20 identified by the corresponding mobile body ID. The moving state is represented by, for example, "stopping" representing that the mobile body is stopped, "moving" representing that the mobile body is moving, or the like. The service state is information indicating a service provision state by the mobile body 20. The service state is represented by, for example, "in service" representing that the product G is on sale, "in transit" representing that the product G is traveling without being sold, and the like.

The disposed product is information indicating the type of the product G loaded on the mobile body 20 identified by the corresponding mobile body ID. The inventory information is information indicating the inventory quantity of each of the products G loaded on the mobile body 20 identified by the corresponding mobile body ID.

The battery state is information indicating the remaining amount of the driving energy of the mobile body 20 identified by the corresponding mobile body ID. In the present embodiment, a mode in which the mobile body 20 is an electric vehicle (EV) that travels using the electricity accumulated in the battery as power will be described as an example. Therefore, a mode in which the charge state of the battery installed in the mobile body 20 is registered as the battery state in the mobile body management information 14A will be described as an example. Note that the mobile body 20 may be an engine vehicle that travels using fossil fuel such as gasoline or light oil as power, a hybrid vehicle that travels using both electricity and fossil fuel as power, or the like.

The route information is information indicating a route R of an autonomously traveling target of the mobile body 20 identified by the corresponding mobile body ID.

FIG. 3B is a schematic diagram of an example of a data configuration of the product management information 14B.

The product management information 14B is information for managing the product G loaded on each of the plurality of mobile bodies 20 to be managed by the management device 10. Specifically, the product management information 14B is, for example, information in which a product ID, a product name, a product classification, a product unit price, the presence or absence of an advertising effect, a sales eligible target, and a sales recommendation target are associated with each other.

The product ID is identification information of the product G. The product name is information indicating the name of the product G identified by the corresponding product ID. The product classification is information indicating a classification name of the product G identified by the corresponding product ID. The product unit price is information indicating the unit price of the product G identified by the corresponding product ID.

The presence or absence of an advertising effect is information indicating whether the product G identified by the corresponding product ID has an advertising effect. Specifically, the presence or absence of an advertising effect is information indicating whether the product G exhibits an advertising effect to another user who has confirmed the product G by the user C who has purchased the product G eating the product G or carrying it in a manner visible to another user. For example, the presence or absence of an advertising effect is expressed by "have" indicating having the advertising effect or "do not have" indicating not having the advertising effect.

The sales eligible target is information indicating an attribute of the user C to whom it is possible to sell the product G identified by the corresponding product ID. For example, in a case where there is an age restriction on the use of the product G, information such as "users who are N years old or older" according to the age restriction is registered as a sales eligible target. N is an integer of 0 or more. In addition, in a case where the product G is available to all the users C, "all the users" are registered as a sales eligible target.

The sales recommendation target represents an attribute of the user C who is a target to whom the product G identified by the corresponding product ID is sold. The sales recommendation target is represented by, for example, "adult women", "children", and the like.

Returning to FIG. 2, the description will be continued. The control unit 15 is a computer that executes information processing in the management device 10. The control unit 15 may be realized by causing a processor such as a central processing unit (CPU) to execute a program, that is, by software.

In the present embodiment, the control unit 15 executes information processing such as update of the mobile body management information 14A and the product management information 14B, and transmission of response information corresponding to request information such as inquiry information received from the mobile body 20.

Specifically, the control unit 15 receives, from the mobile body 20, mobile body information including a mobile body ID of the mobile body 20, mobile body position information, a moving state, a service state, a disposed product, inventory information, a battery state, and route information every predetermined time. The predetermined time is, for example, every several seconds, every several minutes, or the like, but may be set in advance. The control unit 15 registers the received mobile body information in the mobile body management information 14A in association with the mobile body ID included in the mobile body information. Therefore, the mobile body management information 14A is updated by the control unit 15 so that the latest mobile body information of each of the plurality of mobile bodies 20 to be managed included in the mobile body control system 1 is registered.

Furthermore, the control unit 15 registers, in the product management information 14B, information about product management input by an operation instruction or the like given to the input unit 12 by a user such as an administrator. Furthermore, the control unit 15 may appropriately change the mobile body management information 14A according to an operation instruction or the like given to the input unit 12 by the user. The route information about the mobile body management information 14A may be set in advance for each mobile body 20 according to an operation instruction or the like to the input unit 12 by a user such as an administrator.

Further, before the start of the autonomous movement of the mobile body 20, the control unit 15 reads the product management information corresponding to the product ID of each of the products G loaded on the mobile body 20 from the product management information 14B, to transmit the read product management information to the mobile body 20. Further, before the start of the autonomous movement of the mobile body 20, the control unit 15 reads the route information corresponding to the mobile body ID of the mobile body 20 from the mobile body management information 14A, to transmit the route information to the mobile body 20. In addition, the control unit 15 transmits response information corresponding to request information such as inquiry information received from the mobile body 20 to the mobile body 20. Details of the request information such as the inquiry information will be described later.

Next, the information processing terminal 18 will be described.

The information processing terminal 18 includes a communication unit 18A, an input unit 18B, an output unit 18C, a storage unit 18D, a sensor 18E, and a control unit 18F. The communication unit 18A, the input unit 18B, the output unit 18C, the storage unit 18D, the sensor 18E, and the control unit 18F are communicably connected via a bus or the like.

The communication unit 18A is a communication interface that communicates with the management device 10, the mobile body 20, and the like via the network NW and the like. The input unit 18B receives various operations by the user. The input unit 18B is, for example, a pointing device such as a keyboard and a mouse, a microphone, or the like. The output unit 18C outputs various types of information. The output unit 18C is a display that displays various types of information, a speaker that outputs various types of sound, or the like. Note that the input unit 18B and the output unit 18C may be integrally configured as a touch panel. The storage unit 18D stores various pieces of data. The sensor 18E is a sensor that detects various events. For example, the sensor 18E includes at least a position sensor (global navigation satellite system (GNSS), global positioning system (GPS)) that detects position information of the information processing terminal 18. The sensor 18E may include an imaging unit or the like that acquires a captured image by imaging. The control unit 18F is a computer that executes information processing in the information processing terminal 18.

Next, the mobile body 20 will be described in detail.

The mobile body 20 includes a communication unit 21, an input unit 22, an output unit 23, a sensor 24, a drive unit (driver) 25, a storage unit 26, a selling operation unit 27, and a control unit 30. The communication unit 21, the input unit 22, the output unit 23, the sensor 24, the drive unit 25, the storage unit 26, the selling operation unit 27, and the control unit 30 are communicably connected via a bus or the like.

The communication unit 21 is a communication interface that communicates with the management device 10, the information processing terminal 18, and the like via the network NW and the like. The input unit 22 receives various operations by the user. The input unit 22 is, for example, a pointing device such as a keyboard and a mouse, an input button, a microphone, or the like. The output unit 23 outputs various types of information. The output unit 23 is a display that displays various types of information, a speaker that outputs various types of sound, or the like. Note that the input unit 22 and the output unit 23 may be integrally configured as a touch panel.

The sensor 24 is a sensor that acquires a travel environment of the mobile body 20. The travel environment is, for example, observation information about the mobile body 20 or information around the mobile body 20. The sensors 24 are, for example, an internal sensor and an external sensor.

The internal sensor is a sensor that observes observation information. The observation information includes at least position information about the mobile body 20. The position information may be a relative position or an absolute position. In the present embodiment, a mode in which the position information is an absolute position represented by latitude and longitude will be described as an example. The internal sensor includes, for example, a position sensor (GNSS, GPS). In addition, the observation information may include speed, acceleration, and the like. In this case, the internal sensor further includes, for example, an inertial measurement unit (IMU), an acceleration sensor, a speed sensor, a rotary encoder, and the like.

The external sensor observes information around the mobile body 20. The external sensor may be mounted in the mobile body 20 or may be mounted outside the mobile body 20. The outside of the mobile body 20 is, for example, another mobile body 20 other than the mobile body 20, an external device, or the like. Hereinafter, another mobile body 20 other than the mobile body 20 may be referred to as another mobile body.

The surrounding information is information indicating a situation around the mobile body 20. The surroundings of the mobile body 20 are a region within a predetermined range from the mobile body 20. This range is an observable range of the external sensor. This range may be set in advance.

The surrounding information is, for example, at least one of a captured image and distance information of the surroundings of the mobile body 20. The captured image is captured image data obtained by imaging. Hereinafter, the captured image data will be simply referred to as a captured image. The distance information is information indicating a distance from the mobile body 20.

The external sensor is, for example, an imaging device that obtains a captured image by imaging, a distance sensor, or the like. The distance sensor is, for example, a millimeter-wave radar, a laser sensor, a distance image sensor, or the like. The captured image is digital image data defining a pixel value for each pixel, a depth map defining a distance from the sensor 24 for each pixel, or the like. The laser sensor is, for example, a two-dimensional laser imaging detection and ranging (LiDAR) sensor or a three-dimensional LiDAR sensor installed in parallel with a horizontal plane.

The drive unit 25 is a device that is mounted in the mobile body 20 and performs driving related to the movement of the mobile body 20. The drive unit 25 is, for example, an engine, a motor, a wheel, or the like. The drive unit 25 is driven under the control of the control unit 30. For example, the control unit 30 determines a surroundings situation based on information or the like obtained from the sensor 24, and controls an accelerator amount, a brake amount, a steering angle, and the like. For example, the control unit 30 controls the drive unit 25 of the mobile body 20 so that the mobile body 20 autonomously moves according to a predetermined route R.

The storage unit 26 stores various pieces of data. The storage unit 26 is, for example, a semiconductor memory element such as a RAM or a flash memory, a hard disk, an optical disk, or the like. Note that the storage unit 26 may be a storage device provided outside the mobile body 20. Furthermore, the storage unit 26 may be a storage medium in which programs and various types of information are downloaded via a LAN, the Internet, or the like and stored or temporarily stored.

In the present embodiment, the storage unit 26 stores product management information 26A.

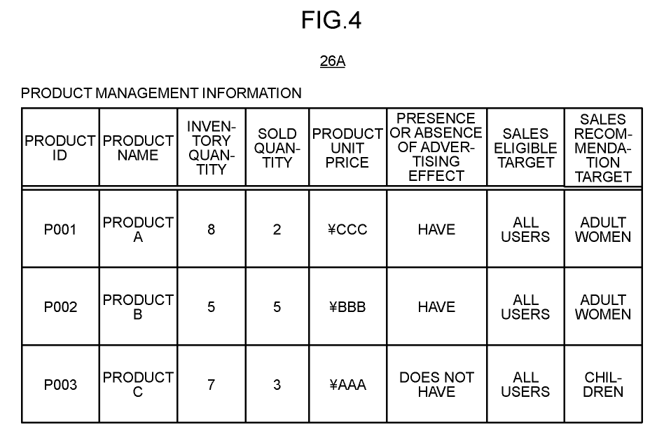

FIG. 4 is a schematic diagram of an example of a data configuration of the product management information 26A. The product management information 26A is information for managing the product G loaded on the product storage unit 20A of the mobile body 20. Specifically, the product management information 26A is, for example, information in which a product ID, a product name, an inventory quantity, a sold quantity, a product unit price, the presence or absence of an advertising effect, a sales eligible target, and a sales recommendation target are associated with each other.

The inventory quantity is information indicating the quantity of inventory currently loaded on the mobile body 20 having the product G identified by the corresponding product ID. The sold quantity is information indicating the number of sold products G identified by the corresponding product ID.

Information other than the inventory quantity and the sold quantity in the product management information 26A is adjusted in advance to be the same as information registered in the product management information 14B of the management device 10 and corresponding to the product ID of the product G loaded on the mobile body 20 in the product management information 14B. For example, the control unit 15 of the management device 10 performs control to read information associated with the product ID of the product G loaded on the mobile body 20 from the product management information 14B and register the read information in the product management information 14B stored in the storage unit 14 of the mobile body 20. The inventory quantity and the sold quantity in the product management information 26A are updated by the control unit 30 of the mobile body 20.

Returning to FIG. 2, the description will be continued.

The selling operation unit 27 performs an operation related to selling of the product G loaded on the mobile body 20. Specifically, the selling operation unit 27 provides the product G loaded on the product storage unit 20A provided in the mobile body 20 to the user C via a product outlet 20B in response to an operation instruction or the like given to the input unit 22 by the user C. In addition, the selling operation unit 27 executes the payment reception process, the settlement process, and the like of the price of the product G according to information input by an operation instruction or the like given to the input unit 22 by the user C. When the payment reception process and the settlement process for the product G are completed, the selling operation unit 27 provides the product G to the user C via the product outlet 20B. The method of the payment of the price by the user C is not limited to either cash or electronic money.

In addition, every time the product G loaded in the product storage unit 20A is sold to the user C, the selling operation unit 27 detects the inventory quantity and the sold quantity of the products G to output the detection result to the control unit 30. The control unit 30 of the mobile body 20 registers the inventory quantity and the sold quantity of the products G indicated by the detection result in the product management information 26A. Therefore, information indicating the latest inventory quantity and sold quantity is registered in the product management information 26A for each product G identified by each product ID. In addition, every time the control unit 30 of the mobile body 20 updates the product management information 26A, the control unit 30 transmits sales information including the mobile body ID of the mobile body 20, the product ID of the product G which is the detection result, and the inventory quantity to the management device 10. The control unit 15 of the management device 10 registers the product ID and the inventory quantity included in the sales information received from the mobile body 20 in the mobile body management information 14A in association with the mobile body ID included in the sales information. Therefore, the latest inventory information of the product G loaded on the mobile body 20 is registered in the mobile body management information 14A.

Next, the control unit 30 of the mobile body 20 will be described in detail.

The control unit 30 of the mobile body 20 is a computer that controls the mobile body 20 that autonomously moves and sells the product G. The control unit 30 includes a movement control unit 30A, a detection unit 30B, a specification unit 30C, an operation execution unit 30D, a stop continuation determination unit 30E, and a stop continuation control unit 30F. The movement control unit 30A, the detection unit 30B, the specification unit 30C, the operation execution unit 30D, the stop continuation determination unit 30E, and the stop continuation control unit 30F are realized by one or a plurality of processors. For example, each of the above units may be realized by causing a processor such as a central processing unit (CPU) to execute a program, that is, by software.

Each of the above units may be realized by a processor such as a dedicated IC, that is, hardware. Each of the above units may be realized using software and hardware in combination. In a case where a plurality of processors is used, each processor may implement one of the units or two or more of the units. Furthermore, at least one of one or a plurality of functional units included in the control unit 30 may be mounted on an external information processing device communicably connected to the mobile body 20 via the network NW or the like.

The movement control unit 30A causes the drive unit 25 to autonomously move the mobile body 20. For example, the movement control unit 30A controls the drive unit 25 so that the mobile body 20 autonomously moves along the route R represented by the route information corresponding to the mobile body ID of the mobile body 20 in the mobile body management information 14A using the captured image acquired by the sensor 24, the position information about the mobile body 20 detected by the sensor 24, and the like. The route R along which the mobile body 20 autonomously moves is defined in advance in, for example, the mobile body management information 14A managed by the management device 10, and the map information of the real space including the route R and the route R is stored in advance in the storage unit 26 of the mobile body 20. The movement control unit 30A controls the drive unit 25 so that the mobile body 20 travels along the route R using the map information, the information about the route R, the position information detected by the sensor 24, the captured image acquired by the sensor 24, and the like. The mobile body 20 autonomously travels along the route R under the control of the drive unit 25 by the movement control unit 30A.

The detection unit 30B detects purchase intention of the first user C1. The first user C1 is an example of the user C. For example, the detection unit 30B detects purchase intention of the first user C1 during autonomous traveling of the mobile body 20.

The purchase intention means intention of the user C to purchase the product G.

For example, the detection unit 30B detects the user C included in the captured video by analyzing the captured video which is the time series captured images around the mobile body 20 acquired by the sensor 24, and determines whether the user C has performed a predetermined operation. The predetermined operation is a predetermined operation indicating purchase intention. Specifically, the predetermined operation is, for example, an operation of raising a hand, and is determined in advance. In a case where it is determined that the user C included in the captured video has performed the predetermined operation by the analysis of the captured video, the detection unit 30B identifies the user C as a first user C1 having purchase intention. The detection unit 30B detects purchase intention of the first user C1 through these identifying processes.

In addition, the detection unit 30B may detect purchase intention in response to an operation instruction given to the information processing terminal 18 by the first user C1.

Specifically, when the first user C1 who desires to purchase the product G operates the input unit 18B of the information processing terminal 18 of the first user C1, the control unit 18F of the information processing terminal 18 transmits the information about the request for calling the mobile body 20 to the management device 10. The information about the request for calling the mobile body 20 includes position information of the information processing terminal 18 and a request signal for calling the mobile body 20.

Note that the position information included in the call request information is not limited to the current position information of the information processing terminal 18. For example, the position information included in the call request information may be information indicating a position in the real space where the first user C1 desires to call the mobile body 20.

Upon receiving the call request information, the control unit 15 of the management device 10 transmits the received call request information to the mobile body 20. For example, the control unit 15 of the management device 10 identifies, from the mobile body management information 14A, the mobile body 20 traveling autonomously closest to the position indicated by the position information included in the received call request information. Then, the control unit 15 may transmit the call request information to the identified mobile body 20. The detection unit 30B of the mobile body 20 receives the call request information from the management device 10 to detect purchase intention of the first user C1.

Further, when the first user C1 who desires to purchase the product G operates the input unit 18B of the information processing terminal 18, the control unit 18F of the information processing terminal 18 may directly transmit the call request information to the mobile body 20 without passing through the management device 10. In this case, the detection unit 30B of the mobile body 20 detects purchase intention of the first user C1 by receiving the call request information from the information processing terminal 18.

The specification unit 30C specifies a first stop position at which the mobile body 20 is stopped.

This will be described with reference to FIG. 1. A first stop position P1 is a position in real space where the mobile body 20 is stopped for selling the product G to the first user C1 when the purchase intention of the first user C1 is detected. The first stop position P1 is a position where the mobile body 20 can stop around the first user C1. That is, when detecting the purchase intention of the first user C1, the specification unit 30C specifies the stoppable position around the first user C1 as the first stop position P1. The specification unit 30C may specify the stoppable position of the mobile body 20 using the map information, the captured image around the mobile body 20, and the like.

Returning to FIG. 2, the description will be continued. Specifically, the specification unit 30C first identifies the position in the real space of the first user C1 whose purchase intention has been detected.

For example, it is assumed that the detection unit 30B detects the purchase intention of the first user C1 by analyzing a captured video which is a time series captured images around the mobile body 20, the captured images being acquired by the sensor 24. In this case, the specification unit 30C identifies the position of the first user C1 by analyzing the captured video. Specifically, the specification unit 30C identifies the position of the first user C1 in the real space using the position information about the mobile body 20 detected by the sensor such as the GPS included in the sensor 24, the direction of the first user C1 with reference to the mobile body 20 identified by the analysis of the captured video, and the distance information from the mobile body 20 to the first user C1, the distance information being indicated by the laser sensor, the depth map, or the like included in the sensor 24.

In addition, for example, it is assumed that the detection unit 30B detects purchase intention in response to an operation instruction given to the information processing terminal 18 by the first user C1. In this case, the specification unit 30C identifies the position information included in the call request information received directly from the information processing terminal 18 or via the management device 10 from the information processing terminal 18, thereby identifying the position information as the position of the first user C1.

Next, the specification unit 30C specifies the stoppable position closest to the first user C1 as the first stop position P1 based on the identified position of the first user C1.

For example, the storage unit 26 of the mobile body 20 stores in advance map information including information about the route R for autonomous movement and the stoppable region of the mobile body 20. The specification unit 30C specifies a position in the stoppable region closest to the first user C1 as the first stop position P1 using the position of the identified first user C1 and the map information.

Furthermore, for example, information about an unstoppable region of the mobile body 20 may be registered in the map information instead of the stoppable region. In this case, the specification unit 30C specifies, as the first stop position P1, a position closest to the first user C1 and in a region outside the unstoppable region using the position of the identified first user C1 and the map information.

When the first stop position P1 is specified by the specification unit 30C, the movement control unit 30A causes the drive unit 25 to move the mobile body 20 and stop the mobile body 20 at the first stop position P1. Therefore, the mobile body 20 autonomously travels to the first stop position P1 and stops at the first stop position P1 which is a stoppable position near the first user C1.

When the mobile body 20 stops at the first stop position P1, the operation execution unit 30D causes the selling operation unit 27 to execute the selling operation related to selling of the product G.

Specifically, the operation execution unit 30D receives, from the first user C1, the input of the purchase information about the product G whose purchase is desired.

For example, the operation execution unit 30D displays a list of the products G loaded on the product storage unit 20A on the output unit 23, and receives the input of the purchase information about the product G whose purchase is desired by receiving the operation instruction given to the input unit 22 by the first user C1.

Furthermore, for example, the operation execution unit 30D may display a QR code (registered trademark) representing a list of the products G loaded on the product storage unit 20A on the output unit 23 to prompt read of the QR code to the information processing terminal 18. In this case, the control unit 18F of the information processing terminal 18 reads the QR code displayed on the output unit 23 and displays a list of the products G represented by the QR code on the output unit 18C. The first user C1 operates the input unit 18B of the information processing terminal 18 to input the product G whose purchase is desired from the list of the products G displayed on the output unit 18C of the information processing terminal 18. When the control unit 18F of the information processing terminal 18 transmits the purchase information indicating the purchase wish product whose input has been received to the mobile body 20, the operation execution unit 30D of the mobile body 20 receives the input of the purchase information related to the product G whose purchase is desired.

Then, the operation execution unit 30D executes the settlement process for the product G whose purchase is desired. For example, the operation execution unit 30D causes the selling operation unit 27 to execute the payment reception process, the settlement process, and the like for receiving payment of the price of the product G. For example, the operation execution unit 30D may execute the settlement process by making a settlement by an external settlement system via the communication unit 21. Furthermore, the operation execution unit 30D may include a settlement system.

When the payment reception process and the settlement process for the product G are completed, the movement control unit 30A provides the purchased product G to the first user C1 via the product outlet 20B. The first user C1 receives the purchased product G from the product outlet 20B.

The stop continuation determination unit 30E determines whether to continue stopping at the first stop position P1 based on the situation information about the mobile body 20 at the end of the selling operation.

The situation information indicates information about at least one of the situation of the mobile body 20, the situation around the mobile body 20, and the usage situation of the mobile body 20 at the end of the operation of selling to the first user C1.

First, the stop continuation determination unit 30E determines whether the operation of selling to the first user C1 has ended.

For example, the stop continuation determination unit 30E determines whether the operation of selling to the first user C1 has ended by determining whether the receipt of the product G by the first user C1 has been completed. Specifically, the configuration in which an imaging device that images the product outlet 20B is installed is provided, and the stop continuation determination unit 30E analyzes the captured image of the product outlet 20B captured by the imaging device to determine whether the receipt of the product G by the first user C1 is completed. In addition, the configuration in which a weight sensor is installed in the product outlet 20B is provided, and the stop continuation determination unit 30E determines whether the receipt of the product G by the first user C1 is completed using the weight change detected by the weight sensor. Further, the configuration in which an opening and closing sensor is installed at the door of the product outlet 20B is provided, and the stop continuation determination unit 30E determines whether the receipt of the product G by the first user C1 is completed using the opening and closing operation detected by the opening and closing sensor.

When determining that the operation of selling to the first user C1 is ended, the stop continuation determination unit 30E acquires the situation information about the mobile body 20 that is the host vehicle.

For example, the stop continuation determination unit 30E acquires the situation information by acquiring the captured image of the surroundings of the mobile body 20 captured by the imaging device included in the sensor 24. Further, for example, the stop continuation determination unit 30E acquires the situation information by acquiring a detection result detected by another sensor other than the imaging device included in the sensor 24. Specifically, the stop continuation determination unit 30E acquires the situation information by acquiring the ambient air temperature detected by the air temperature sensor, the ambient brightness detected by the illuminance sensor, the situation of the surroundings obstacle detected by the obstacle sensor, and the like. The situation of the obstacle is, for example, information indicating whether it is a place surrounded by an object such as a fence or a wall.

In addition, the stop continuation determination unit 30E acquires the number of purchased products G, the purchase amount of the product, the battery status of the mobile body 20, and the like from the selling operation unit 27, the storage unit 26, the sensor that measures the remaining amount of the battery, and the like, thereby acquiring the situation information. In addition, the stop continuation determination unit 30E acquires, from the management device 10, history information for each mobile body 20 such as a sales history of the product G and a stop history based on detection of purchase intention, inventory information and position information about the product G of another mobile body, and the like as situation information.

In addition, the stop continuation determination unit 30E may acquire the situation information from an external system or the like outside the mobile body 20 based on the position information about the mobile body 20. For example, the stop continuation determination unit 30E may acquire the situation information by acquiring captured images from an external system that manages various monitoring cameras installed in the real space. In this case, the stop continuation determination unit 30E transmits a situation information acquisition request including the position information about the mobile body 20 and the mobile body ID of the mobile body 20 to the management device 10 or the external system. The external system that has received the situation information acquisition request via the management device 10 or directly from the mobile body 20 identifies a monitoring camera whose imaging range is a region including a position indicated by the position information included in the situation information acquisition request. Then, the external system may transmit the captured image captured by the identified monitoring camera to the mobile body 20 that is the transmission source of the situation information acquisition request directly or via the management device 10. The stop continuation determination unit 30E acquires the situation information by receiving the captured image. In addition, the stop continuation determination unit 30E may acquire the situation information from another mobile body present around the mobile body 20.

In addition, the stop continuation determination unit 30E may acquire the situation information by acquiring environmental information such as weather information, air temperature information, and humidity information of the surroundings region including the current position of the mobile body 20 from an external system that provides the environmental information.

Then, the stop continuation determination unit 30E determines whether to continue stopping at the first stop position P1 based on the acquired situation information. Specifically, the stop continuation determination unit 30E determines whether to continue stopping at the first stop position P1 based on the situation information at the end of the operation of selling to the first user C1.

For example, the stop continuation determination unit 30E determines whether to continue stopping at the first stop position P1 according to the situation information indicating the presence situation of a second user C2 other than the first user C1, the second user C2 being present around the mobile body 20. The second user C2 is another user C other than the first user C1.

In this case, the stop continuation determination unit 30E analyzes the acquired situation information to determine whether there is the second user C2, who is another user C other than the first user C1, around the mobile body 20. For example, the stop continuation determination unit 30E analyzes the captured image captured by the imaging device included in the sensor 24 to determine whether the second user C2, who is another user C other than the first user C1, is present around the mobile body 20. Then, in a case where the second user C2 is present around the mobile body 20, the stop continuation determination unit 30E determines to continue stopping at the first stop position P1. Further, in a case where the second user C2 is not present around the mobile body 20, the stop continuation determination unit 30E determines not to continue stopping at the first stop position P1.

The stop continuation determination unit 30E determines to continue stopping at the first stop position P1 in a case where the second user C2 is present around the mobile body 20, so that it is possible to suppress a loss of an opportunity to sell to the second user C2.

In addition, the stop continuation determination unit 30E analyzes the acquired situation information to determine whether the number of second users C2 who are other users C other than the first user C1, the second user C2 being present around the mobile body 20, is equal to or larger than a threshold value. The threshold value may be set in advance. For example, the stop continuation determination unit 30E analyzes the captured image captured by the imaging device included in the sensor 24 to determine whether the number of second users C2 who are other users C other than the first user C1, the second user C2 being present around the mobile body 20, is equal to or larger than the threshold value. Then, in a case where the second user C2 whose number is equal to or larger than the threshold value is present around the mobile body 20, the stop continuation determination unit 30E determines to continue stopping at the first stop position P1. Further, in a case where there is no second user C2 whose number is equal to or more than the threshold value around the mobile body 20, the stop continuation determination unit 30E determines not to continue stopping at the first stop position P1.

In a case where the second users C2, who are other users C other than the first user C1, and the number of whom is equal to or larger than the threshold value, are present around the mobile body 20, the opportunity to sell to the second users C2 whose number is equal to or larger than the threshold value can be increased by continuing the stop at the first stop position P1. Therefore, it is possible to suppress a loss of an opportunity to sell to the second user C2.

In addition, the stop continuation determination unit 30E analyzes the acquired situation information to determine whether the distance to the second user C2 who is another user C other than the first user C1, the second user C2 being present around the mobile body 20, is less than the threshold value. The threshold value may be set in advance. For example, the stop continuation determination unit 30E analyzes the captured image and the distance information captured by the imaging device included in the sensor 24 to determine whether the distance to the second user C2, who is another user C other than the first user C1, the second user C2 being present around the mobile body 20, is less than the threshold value. Then, in a case where the distance to the second user C2 present around the mobile body 20 is less than the threshold value, the stop continuation determination unit 30E determines to continue stopping at the first stop position P1. Further, in a case where the distance to the second user C2 present around the mobile body 20 is equal to or more than the threshold value, the stop continuation determination unit 30E determines not to continue stopping at the first stop position P1.

In a case where the distance from the mobile body 20 to the second user C2 is equal to or more than the threshold value, a burden is generated in the movement of the second user C2 to the first stop position P1 of the mobile body 20, and thus, there is a low possibility that the sales opportunity can be improved. Therefore, in a case where the distance to the second user C2 present around the mobile body 20 is less than the threshold value, the stop continuation determination unit 30E determines to continue stopping at the first stop position P1, whereby deterioration of the sales efficiency can be suppressed.

In addition, the stop continuation determination unit 30E analyzes the acquired situation information to determine whether the number of users C present in a region where the distance from the mobile body 20 is less than the threshold value is larger than a predetermined number. The threshold value and the predetermined number may be set in advance. For example, the stop continuation determination unit 30E analyzes the captured image and the distance information captured by the imaging device included in the sensor 24, thereby identifying the number of users C present in the region where the distance from the mobile body 20 is less than the threshold value. Then, in a case where the number of identified users C is larger than the predetermined number, the stop continuation determination unit 30E determines to continue stopping at the first stop position P1. In a case where the number of identified users C is equal to or smaller than the predetermined number, the stop continuation determination unit 30E determines not to continue stopping at the first stop position P1. Through these determination processes, the stop continuation determination unit 30E can suppress deterioration of sales efficiency.

In addition, for example, in a case where the attribute of the second user C2 other than the first user C1, the second user C2 being present around the mobile body 20, the attribute being indicated by the situation information, is at least one of the sales promotion target and the sales eligible target of the product G loaded on the mobile body 20, the stop continuation determination unit 30E determines to continue stopping at the first stop position P1.

In this case, the stop continuation determination unit 30E identifies the attribute of the second user C2 present around the mobile body 20 by analyzing the acquired situation information. For example, the stop continuation determination unit 30E identifies the attribute of the second user C2 by analyzing the captured image captured by the imaging device included in the sensor 24. Then, in a case where the identified attribute of the second user C2 matches at least one of the sales eligible target and the sales recommendation target registered in the product management information 26A, the stop continuation determination unit 30E determines to continue stopping at the first stop position P1. Further, in a case where the identified attribute of the second user C2 matches none of the sales eligible target and the sales recommendation target registered in the product management information 26A, the stop continuation determination unit 30E determines not to continue stopping at the first stop position P1.

Specifically, for example, it is assumed that the product G loaded on the mobile body 20 is a product G having a sales recommendation target "adult woman". In this case, there is a possibility of a sales opportunity in a case where the second user C2 present around the mobile body 20 is an adult woman, but there is a low possibility of a sales opportunity if the second user C2 is a man. In addition, for example, in a case where the product G loaded on the mobile body 20 is the product G such as alcoholic beverages having a sales eligible target "20 years or older", there is a possibility of a sales opportunity in a case where the second user C2 present around the mobile body 20 is an adult of 20 years or older, but there is a low possibility of a sales opportunity if the second user C2 is a child.

Therefore, the stop continuation determination unit 30E determines whether to continue stopping at the first stop position P1 according to whether the attribute of the second user C2 present around the mobile body 20 is at least one of the sales promotion target and the sales eligible target of the product G loaded on the mobile body 20, whereby it is possible to suppress the deterioration of the sales efficiency and suppress the loss of the sales opportunity.

Further, for example, in a case where the product G purchased by the first user C1, the product G being indicated by the situation information, is a predetermined subject having an advertising effect for the second user C2 around the mobile body 20 who is another user C other than the first user C1, the stop continuation determination unit 30E determines to continue stopping at the first stop position P1.

In this case, the stop continuation determination unit 30E confirms, from the product management information 26A, the presence or absence of the advertising effect for the product ID of the product G purchased by the first user C1. As described above, the presence or absence of the advertising effect is information indicating whether the product G identified by the corresponding product ID has an advertising effect.

Specifically, for example, it is assumed that the product G purchased by the first user C1 is a soft cream that is highly likely to be eaten immediately after purchase. As described above, the product G that is likely to be eaten immediately after purchase is subject to use such as that the first user C1 eats the product G in a state visible to the second user C2 that is another user C. Therefore, the product G stimulates the purchase desire of the other user C, and has an advertising effect on the other user C. Therefore, in the product management information 26A and the product management information 14B, "have" indicating having the advertising effect is registered in advance as the presence or absence of the advertising effect corresponding to the product ID of the product G.

On the other hand, in a case where the product G purchased by the first user C1 is a product G that is less likely to be used immediately after purchase or a product G having a small size that is less likely to be visually recognized by the other user C, the product G is less likely to be confirmed by other users C. This is because, in the case of the product G that is unlikely to be used immediately after purchase, the product G cannot be confirmed from the outside by being stored in a bag or the like of the first user C1. In addition, this is because, in the case of the product G having a small size that is hardly confirmed by the other user C, there is a high possibility that the product G is hardly confirmed from the outside due to the small size.

For this reason, such a product G is less likely to stimulate the purchase desire of the other user C than the product G having the advertising effect, and does not have the advertising effect. Therefore, in the product management information 26A and the product management information 14B, "do not have" indicating not having the advertising effect is registered in advance as the presence or absence of the advertising effect corresponding to the product ID of the product G.

In a case where the presence or absence of the advertising effect for the product ID of the product G purchased by the first user C1 in the product management information 26A is "have" indicating having the advertising effect, the stop continuation determination unit 30E determines to continue stopping at the first stop position P1. Further, in a case where the presence or absence of the advertising effect for the product ID of the product G purchased by the first user C1 in the product management information 26A is "do not have" indicating not having the advertising effect, the stop continuation determination unit 30E determines not to continue stopping at the first stop position P1.

The stop continuation determination unit 30E may track, by the imaging device included in the sensor 24, the first user C1 who has purchased the product G, determine that the product G has an advertising effect in a case where the product G purchased by the first user C1 is included in the captured image captured by the imaging device, and determine to continue stopping at the first stop position P1.

Further, the stop continuation determination unit 30E may track, by the imaging device included in the sensor 24, the first user C1 who has purchased the product G, determine that the product G has an advertising effect in a case where the product G purchased by the first user C1 is included in the captured image captured by the imaging device for a predetermined period or longer, and determine to continue stopping at the first stop position P1.

Furthermore, for example, the stop continuation determination unit 30E may determine whether to continue stopping at the first stop position P1 according to the inventory quantity of the products G purchased by the first user C1 indicated by the situation information.

In this case, in a case where the inventory quantity of the products G purchased by the first user C1 is a certain number or more, the stop continuation determination unit 30E determines to continue stopping at the first stop position P1. The stop continuation determination unit 30E may perform the above determination by identifying the inventory quantity for the product ID of the product G purchased by the first user C1 from the product management information 26A. In a case where the inventory quantity of the products G purchased by the first user C1 is less than a certain number, the stop continuation determination unit 30E determines not to continue stopping at the first stop position P1. This is because, in a case where the inventory quantity of the products G purchased by the first user C1 is less than a certain number, the product G cannot be sold to the second user C2 even in a case where the product G is a product G having an advertising effect. Therefore, deterioration of sales efficiency can be suppressed by these processes.

Note that the stop continuation determination unit 30E may perform the following processing in a case where the inventory quantity of the products G purchased by the first user C1 is less than a certain number. Specifically, the stop continuation determination unit 30E may transmit the movement request information including the position information of the first stop position P1 and the movement instruction to the first stop position P1 to another mobile body carrying the product G having an inventory quantity of one or more. More specifically, the stop continuation determination unit 30E transmits, to the management device 10, the support request information including the product ID of the product G whose inventory quantity is less than a certain quantity and the support request. The support request information is an example of the request information. The control unit 15 of the management device 10 identifies a mobile body ID whose inventory quantity for the product ID included in the support request information is one or more from the mobile body management information 14A. Then, the control unit 15 may transmit, to the mobile body 20 identified by the mobile body ID, call request information including the position information of the first stop position P1 and the request signal for calling the mobile body 20. The other mobile body may be a dedicated vehicle for replenishing the product G.

Further, the stop continuation determination unit 30E may transmit the call request information to another mobile body directly or via the management device 10 in a case where the inventory quantity of the products G is less than a certain number due to the purchase of the product G by the predetermined number or more of users C. This is because, in a case where the inventory quantity of the specific products G is less than a certain number by being sold to one user C once, there is a low possibility that the sales opportunity can be improved even if another mobile body capable of selling the product G is moved to the first stop position P1.

Furthermore, in a case where a plurality of types of products G is loaded on the mobile body 20, the stop continuation determination unit 30E may determine to continue stopping at the first stop position P1 in a case where the stock of a predetermined number or more of types of products G is a certain number or more. A value equal to or less than the number of types of products G loaded on the mobile body 20 may be set in advance as the predetermined number.

Further, in a case of determining that the service provision by the mobile body 20 can be executed at a constant level of quality, the stop continuation determination unit 30E may determine to continue stopping at the first stop position P1.

For example, the mobile body 20 sells ice creams with five types of tastes as a plurality of types of products G and in a case where there is a stock of ice creams with four or more types of tastes, the mobile body continues stopping, and in a case where the stock is three types or less, the mobile body does not continue stopping. In addition, in a case where the service cannot be sufficiently provided, there is a possibility that the expectation of the user C who uses the mobile body 20 cannot be satisfied. Therefore, the stop continuation determination unit 30E may continue stopping only in a case where it is determined that the service can be provided at a certain level of quality.

In addition, in a case where the mobile body detects purchase intention of the user C while moving to the place for replenishing the product G such as a warehouse to replenish the product G, stops and sells the product G, the stop continuation determination unit 30E may determine not to continue stopping.

Further, for example, in a case where at least one of the number of the products G purchased by the first user C1 and the purchase amount of the product G that are indicated by the situation information is a predetermined value or more, the stop continuation determination unit 30E determines to continue stopping at the first stop position P1. In a case where both the number of the products G purchased by the first user C1 and the purchase amount of the product G that are indicated by the situation information are less than predetermined values, the stop continuation determination unit 30E determines not to continue stopping at the first stop position P1.

As the number of the products G to be purchased increases, the advertising effect of the products G increases. In addition, it is indicated that the higher the purchase amount of the product G to be purchased, the larger the number of the products G to be purchased or the more expensive product G has been purchased. Therefore, as the number of products G to be purchased increases, a larger advertising effect can be obtained. In addition, as the more expensive product G is purchased, there is a possibility that a user C who desires to purchase the more expensive product G appears, and improvement in sales is expected. Therefore, in a case where at least one of the number of the products G purchased by the first user C1 and the purchase amount of the product G is equal to or more than the predetermined value, the stop continuation determination unit 30E determines to continue stopping at the first stop position P1, so that it is possible to suppress a loss of a sales opportunity and suppress deterioration of sales efficiency.

Furthermore, for example, in a case where the situation information indicates that another mobile body in which at least some types of products G overlap, the other mobile body being other than the mobile body 20, is not present within the predetermined distance of the mobile body 20, the stop continuation determination unit 30E determines to continue stopping at the first stop position P1.

In this case, the stop continuation determination unit 30E transmits, to the management device 10, inquiry information inquiring whether another mobile body in which at least some types of products G overlap, the other mobile body being other than the mobile body 20, is present within a predetermined distance of the mobile body 20. The inquiry information is an example of the request information. The control unit 15 of the management device 10 that has received the inquiry information identifies, from the mobile body management information 14A, another mobile body present within a predetermined distance from the position indicated by the mobile body position information corresponding to the mobile body ID of the mobile body 20 that is the transmission source of the inquiry information. Then, the control unit 15 further identifies, from the mobile body management information 14A, the mobile body 20 in which at least some disposed products overlap the disposed product for the mobile body ID of the mobile body 20 that is the transmission source of the inquiry information, among the identified other mobile bodies.

In a case where one or more other mobile bodies can be identified by these identifying processes, the control unit 15 determines that another mobile body in which at least some types of products G overlap is present within a predetermined distance of the mobile body 20. In addition, in a case where one or more other mobile bodies cannot be identified by these identifying processes, the control unit 15 determines that another mobile body in which at least some types of products G overlap is not present within the predetermined distance of the mobile body 20. Then, the control unit 15 transmits response information indicating these determination results to the mobile body 20 that is the transmission source of the inquiry information.

In a case where the determination result indicated by the response information received from the management device 10 indicates that another mobile body in which at least some types of products G overlap is not present within the predetermined distance of the mobile body 20, the stop continuation determination unit 30E of the mobile body 20 determines to continue stopping at the first stop position P1. Further, in a case where the determination result received from the management device 10 indicates that another mobile body in which at least some types of products G overlap is present within the predetermined distance of the mobile body 20, the stop continuation determination unit 30E determines not to continue stopping at the first stop position P1.

In a case where the same product G is sold in the same region, the convenience of the user C may deteriorate. Therefore, in a case where another mobile body in which at least some types of the products G overlap is not present within the predetermined distance of the mobile body 20, the stop continuation determination unit 30E determines to continue stopping at the first stop position P1, whereby the convenience of the user C can be improved.

Note that the stop continuation determination unit 30E of the mobile body 20 may determine whether another mobile body in which at least some types of products G overlap is present within a predetermined distance of the mobile body 20 by directly communicating with another mobile body.

Further, the stop continuation determination unit 30E may determine whether to continue stopping at the first stop position P1 according to the inventory quantity, of the products G, indicated by the usage status.

In this case, in a case where the situation information indicates that another mobile body other than the mobile body 20 in which at least some types of the products G overlap and has a larger inventory quantity of the products G than the mobile body 20, is not present within the predetermined distance of the mobile body 20, the stop continuation determination unit 30E determines to continue stopping at the first stop position P1. Note that, at this time, the stop continuation determination unit 30E may suspend the stop of another mobile body in which at least some types of the products G overlap, the other mobile body being other than the mobile body 20, restart the movement of the other mobile body, and sell the product G while moving with respect to the other mobile body. In this case, the convenience of the user C can be improved. Furthermore, in a case where the situation information indicates that another mobile body in which at least some types of the products G overlap, the other mobile body being other than the mobile body 20, the other mobile body having a larger inventory quantity of the products G than the mobile body 20, is present within a predetermined distance of the mobile body 20, the stop continuation determination unit 30E determines not to continue stopping at the first stop position P1. Through these determination processes, the mobile body 20 having the larger inventory quantity of the overlapping products G among the mobile body 20 and another mobile body present around the mobile body 20 can continue stopping at the first stop position P1.

Note that the number of users C present around the mobile body 20 is a predetermined number or more, and it may be difficult for one mobile body 20 to handle selling of the product G. In this case, regardless of the inventory quantity, the stop continuation determination unit 30E may determine that both the mobile body 20 and another mobile body in which at least some types of products G overlap continue stopping at the first stop position P1.

In addition, the stop continuation determination unit 30E may determine another mobile body in which the types of the products G with a predetermined ratio or more overlap as another mobile body in which at least some types of the products G overlap with respect to the mobile body 20. The ratio is, for example, 50% or the like, but is not limited to this value.

Further, for example, in a case where the total number of other mobile bodies other than the mobile body 20 present within the predetermined range including the first stop position P1 of the mobile body 20 indicated by the situation information is less than the threshold value, the stop continuation determination unit 30E determines to continue stopping at the first stop position P1.

In a case where the plurality of mobile bodies 20 is concentratedly disposed in the same region in the real space, service quality of another region where the mobile body 20 is not present may deteriorate. Therefore, the stop continuation determination unit 30E performs the determination, thereby suppressing intensive disposition of the plurality of mobile bodies 20 in one region. The threshold value of the total number of other mobile bodies may be determined in advance. For example, it is assumed that a plurality of sales areas is set in the real space by the management device 10, and the upper limit number of mobile bodies 20 that can be present at the same time is set in advance for each sales area. The upper limit number may be used as a threshold value of the total number of the other mobile bodies.

Furthermore, for example, in a case where the situation information indicates that another mobile body carrying another type of product G that is highly likely to be used together with the type of product G loaded on the mobile body 20 is present within a predetermined distance, the stop continuation determination unit 30E determines to continue stopping at the first stop position P1.

The other type of product G that is highly likely to be used together with a certain type of product G is, for example, the product G whose product classification is a beverage with respect to the product G whose product classification is the food. On the other hand, the other type of product G that is less likely to be used together with a certain type of the product G is, for example, the product G whose product classification is the stationery with respect to the product G whose product classification is the food.

In this case, for example, the stop continuation determination unit 30E transmits, to the management device 10, inquiry information indicating whether another mobile body on which another type of product G that is highly likely to be used together with the type of product G loaded on the mobile body 20 is present within a predetermined distance. The control unit 15 of the management device 10 that has received the inquiry information identifies, from the mobile body management information 14A, another mobile body present within a predetermined distance from the position indicated by the mobile body position information corresponding to the mobile body ID of the mobile body 20 that is the transmission source of the inquiry information.

Then, among the identified other mobile bodies, the control unit 15 identifies a disposed product corresponding to the mobile body ID of the mobile body 20 as the transmission source of the inquiry information and identifies the product classification of the disposed product from the product management information 14B. Further, the control unit 15 identifies another type of product classification to be used together with the product G belonging to the identified product classification from a database or the like in which a relationship between the product classifications is registered in advance. A group of pairs of types of product classifications to be used together may be registered in the database in advance. Then, the control unit 15 identifies, from the mobile body management information 14A, the mobile body 20 carrying the product G identified by the product ID corresponding to the identified another type of product classification. Then, the control unit 15 identifies, as another mobile body, the mobile body 20 other than the mobile body 20 that is the transmission source of the inquiry information, the mobile body 20 carrying the product G identified by the product ID corresponding to the identified another type of product classification, among identified other mobile bodies present within the predetermined distance.

In a case where the other mobile body can be identified, the control unit 15 transmits, to the mobile body 20 as a transmission source of the inquiry information, response information indicating a determination result indicating that another mobile body on which another type of product G that is highly likely to be used together is loaded is present within a predetermined distance. Furthermore, in a case where the other mobile body cannot be identified, the control unit 15 transmits, to the mobile body 20 that is the transmission source of the inquiry information, response information indicating a determination result indicating that another mobile body on which another type of product G that is highly likely to be used together is loaded is not present within the predetermined distance.

In a case where the response information received from the management device 10 indicates that another mobile body carrying another type of the product G that is highly likely to be used together with the type of the product G loaded on the mobile body 20 is present within a predetermined distance, the stop continuation determination unit 30E of the mobile body 20 determines to continue stopping at the first stop position P1. In addition, in a case where the determination result received from the management device 10 indicates that another mobile body carrying another type of the product G that is highly likely to be used together with the type of the product G loaded on the mobile body 20 is not present within the predetermined distance, the stop continuation determination unit 30E determines not to continue stopping at the first stop position P1.

In addition, the movement control unit 30A of the mobile body 20 may control the drive unit 25 so as to move to the surroundings of another mobile body carrying another type of product G that is highly likely to be used together with the type of product G loaded on the mobile body 20. At this time, the movement control unit 30A may be configured to adjust the position to be moved in a predetermined range from the current stop position in the surroundings of the other mobile body. Then, the stop continuation determination unit 30E of the mobile body 20 may determine to continue stopping at the first stop position P1 which is the surroundings of the other mobile body. The surroundings of the other mobile body are, for example, a position adjacent to the other mobile body, but is not limited to this position. In this case, the mobile body 20 can move to the surroundings of another mobile body carrying another type of product G that is highly likely to be used together with the type of product G loaded on the mobile body 20, and can continue stopping.

In addition, the stop continuation determination unit 30E may transmit, to the management device 10, call request information for stopping, around the mobile body 20, another mobile body carrying another type of product G that is highly likely to be used together with the type of product G loaded on the mobile body 20. In this case, the control unit 15 of the management device 10 may transmit the call request information to the other mobile body. Further, the stop continuation determination unit 30E may directly transmit the call request information to the other mobile body. In this case, it is possible to stop, around the mobile body 20, another mobile body carrying another type of product G that is highly likely to be used together with the type of product G loaded on the mobile body 20.

Note that the stop continuation determination unit 30E may determine to continue stopping at the first stop position P1 in a case where a fixed store that sells another type of the product G that is highly likely to be used together with the type of the product G loaded on the mobile body 20 is present within a predetermined distance. Whether the fixed store is present within the predetermined distance may be determined by transmitting inquiry information to the management device 10, as in the determination as to whether another mobile body on which another type of product G that is highly likely to be used together is loaded is present within the predetermined distance.

Further, for example, in a case where it is indicated that the first stop position P1 indicated by the situation information is within a region having a high sales effect, the stop continuation determination unit 30E determines to continue stopping at the first stop position P1.

The region having a high sales effect means a region that satisfies at least one of the following: the number of times the product G has been sold in the same region in the past is one or more; the cumulative number of the products G sold in the same region in the past is a predetermined number or more; and the cumulative number of times of selling of the product G sold in the same region in the past is a predetermined number of times or more. The predetermined number and the cumulative number of times are integers of at least one or more.

In this case, for example, the stop continuation determination unit 30E transmits, to the management device 10, inquiry information as to whether the first stop position P1 is within a region having a high sales effect. The control unit 15 of the management device 10 that has received the inquiry information determines, using the sales history information or the like stored in the storage unit 14, whether a region within a predetermined distance from a position indicated by the mobile body position information corresponding to the mobile body ID of the mobile body 20 that is the transmission source of the inquiry information satisfies at least one of the following: the number of times the product G has been sold in the same region in the past is one or more; the cumulative number of the products G sold in the same region in the past is a predetermined number or more; and the cumulative number of times of selling of the product G sold in the same region in the past is a predetermined number of times or more.

Then, the control unit 15 transmits, to the mobile body 20, response information indicating a determination result indicating that the first stop position P1 is within a region having a high sales effect in a case where a region within a predetermined distance from the position indicated by the mobile body position information corresponding to the mobile body ID of the mobile body 20 that is the transmission source of the inquiry information satisfies at least one of the following: the number of times the product G has been sold in the same region in the past is one or more, the cumulative number of the products G sold in the same region in the past is a predetermined number or more, and the cumulative number of times of selling of the product G sold in the same region in the past is a predetermined number of times or more. In addition, the control unit 15 transmits, to the mobile body 20 as the transmission source of the inquiry information, response information indicating a determination result indicating that the first stop position P1 is out of the region having a high sales effect in a case where a region within a predetermined distance from the position indicated by the mobile body position information corresponding to the mobile body ID of the mobile body 20 as the transmission source of the inquiry information does not satisfy any of the following: the number of times the product G has been sold in the same region in the past is one or more; the cumulative number of the products G sold in the same region in the past is a predetermined number or more; and the cumulative number of times of selling of the product G sold in the same region in the past is a predetermined number of times or more.

In a case where the response information received from the management device 10 indicates that the first stop position P1 is in a region having a high sales effect, the stop continuation determination unit 30E of the mobile body 20 determines to continue stopping at the first stop position P1. Further, in a case where the response information received from the management device 10 indicates that the first stop position P1 is out of the region having a high sales effect, the stop continuation determination unit 30E determines not to continue stopping at the first stop position P1.

Note that the control unit 15 of the management device 10 may make the determination using, as the sales history information used for the determination, sales history information about another mobile body having the same or similar shape as the mobile body 20 that is the transmission source of the inquiry information, another mobile body carrying the same product G as the product G loaded on the mobile body 20 that is the transmission source of the inquiry information, or another mobile body carrying the product same as or similar to the product G loaded on the mobile body 20 that is the transmission source of the inquiry information. By using the sales history information of another mobile body having the same or similar shape as the mobile body 20 that is the transmission source of the inquiry information, it is possible to treat, as a region with a high sales effect, a region where a good sales effect has been obtained due to the influence of the appearance of the mobile body 20.

Further, for example, in a case where the situation information indicates at least one of a first stop history in which the mobile body stops in a region within a predetermined distance from the first stop position P1 a predetermined number of times or more due to detection of the purchase intention and a second stop history in which the mobile body stops in the region within a predetermined period a predetermined number of times or more due to detection of the purchase intention, the stop continuation determination unit 30E determines to continue stopping at the first stop position P1. In a case where the region within the predetermined distance from the first stop position P1 is a region where the mobile body stops a predetermined number of times or more due to detection of the purchase intention or stops a predetermined number of times or more within the predetermined period due to detection of the purchase intention, the region including the first stop position P1 is estimated to be a region where the demand by the user C is high. The predetermined distance and the predetermined period may be determined in advance.

In this case, every time the mobile body 20 stops at the first stop position P1 by the operation execution unit 30D due to detection of the purchase intention by the detection unit 30B, the control unit 30 registers the position information of the first stop position P1, the stop date and time, and the associated stop history information in the storage unit 26 or the storage unit 14 of the management device 10. Then, when the mobile body 20 stops at the first stop position P1 due to detection of new purchase intention and the selling operation is ended, the stop continuation determination unit 30E determines whether the stop history information indicates a first stop history involving stopping a predetermined number of times or more in a region within a predetermined distance from the first stop position P1. Further, when the mobile body 20 stops at the first stop position P1 due to detection of new purchase intention and the selling operation is ended, the stop continuation determination unit 30E determines whether the stop history information indicates a second stop history involving stoppin a predetermined number of times or more within a predetermined period in a region within a predetermined distance from the first stop position P1.

Through these determination processes, the stop continuation determination unit 30E determines whether the situation information indicates at least one of the first stop history and the second stop history, and determines to continue stopping at the first stop position P1 in a case where the situation information indicates at least one of the first stop history and the second stop history. In a case where the situation information does not indicate any of the first stop history and the second stop history, the stop continuation determination unit 30E determines not to continue stopping at the first stop position P1.

In a case where the first stop position P1 is a position at which the mobile body stops in a region within a predetermined distance from the first stop position P1 a predetermined number of times or more due to detection of the purchase intention, or a position at which the mobile body stops in the region a predetermined number of times or more within a predetermined period due to detection of the purchase intention, the region including the position is estimated to be a region in which the demand by the user C is high. Therefore, in a case where the situation information indicates at least one of the first stop history and the second stop history, the stop continuation determination unit 30E determines to continue stopping at the first stop position P1, so that it is possible to suppress the deterioration of the sales efficiency and the loss of the sales opportunity.

In addition, for example, in a case where the first stop position P1 indicated by the situation information can be in a stoppable and not unparkable region, the stop continuation determination unit 30E determines to continue stopping at the first stop position P1. In a case where the first stop position P1 is in a stoppable and unparkable region, the stop continuation determination unit 30E determines not to continue stopping at the first stop position P1.

In this case, the storage unit 26 of the mobile body 20 stores in advance the map information in which the stoppable region and the unparkable region in the real space are defined. Then, the stop continuation determination unit 30E may determine whether the first stop position P1 is in a stoppable region and whether it is in an unparkable region using the map information. Further, the map information may be stored in the storage unit 14 of the management device 10. In this case, the stop continuation determination unit 30E transmits, to the management device 10, inquiry information inquiring whether the first stop position P1 is in a stoppable region and whether it is in an unparkable region. In response to the inquiry information, the control unit 15 of the management device 10 transmits, to the mobile body 20, response information including a determination result indicating whether the first stop position P1 of the mobile body 20 is in a stoppable region and whether it is in an unparkable region. The stop continuation determination unit 30E of the mobile body 20 may determine whether the first stop position P1 is in a stoppable region and whether it is in an unparkable region using the determination result included in the response information.

Further, for example, in a case where the remaining driving energy of the mobile body 20 indicated by the situation information is equal to or more than the threshold value, the stop continuation determination unit 30E determines to continue stopping at the first stop position P1. Further, in a case where the remaining driving energy of the mobile body 20 is less than the threshold value, the stop continuation determination unit 30E determines not to continue stopping at the first stop position P1.

In this case, the stop continuation determination unit 30E may make the determination by determining whether the battery state indicating the remaining amount of the driving energy of the mobile body 20 is equal to or more than the threshold value. As the threshold value of the battery state, a value at which the mobile body 20 can travel to the next destination may be set in advance. The next destination is, for example, a predetermined moving sales point, a point where the mobile body 20 is scheduled to return, a point of a charging station for charging a battery, or the like.

Further, the stop continuation determination unit 30E may determine the time for which the stop is continued at the first stop position P1 according to the remaining amount of the remaining driving energy of the mobile body 20, the remaining amount being indicated by the situation information. For example, the stop continuation determination unit 30E may determine a longer time for which the stop is continued at the first stop position P1 as the remaining amount of the driving energy increases.

In addition, for example, in a case where at least one of the weather, the air temperature, the stopping place, and the stopping time zone that are indicated by the situation information satisfies a predetermined condition, the stop continuation determination unit 30E determines to continue stopping at the first stop position P1.

The weather indicated by the situation information is weather around the mobile body 20 stopping at the first stop position P1. The air temperature indicated by the situation information is an air temperature around the mobile body 20 stopping at the first stop position P1. The stopping place indicated by the situation information means the first stop position P1. The stopping time zone indicated by the situation information is a time zone in which the mobile body 20 stops at the first stop position P1. The stop continuation determination unit 30E may acquire information indicating the weather and the air temperature around the mobile body 20 directly from an external system that provides environmental information or via the management device 10.

For example, the stop continuation determination unit 30E stores the corresponding predetermined condition in the storage unit 26 in advance for each type of the loaded product G. The predetermined condition may be any condition as long as the sales effect can be obtained for the corresponding type of the product G. In other words, the predetermined condition may be each of the weather, the air temperature, the stopping place, and the stopping time zone in which the demand for the product G is expected.

For example, in a case where the type of the product G is rain gear such as an umbrella, weather "rain" may be set in advance as a predetermined condition representing the weather. In addition, it is assumed that the type of the product G is a product G that is frequently used at the time of the air temperature equal to or higher than the predetermined temperature. Specifically, in a case where the type of the product G is shaved ice, the air temperature such as an air temperature "30°C or higher" may be set in advance as a predetermined condition representing the air temperature. In addition, it is assumed that the type of the product G is a product G that is frequently used at night. In this case, the nighttime time zone may be set in advance as the predetermined condition indicating the time zone corresponding to the type of the product G.

Then, in a case where at least one of the weather, the air temperature, the stopping place, and the stopping time zone indicated by the situation information matches at least one of the predetermined conditions corresponding to the type of the product G loaded on the mobile body 20, the stop continuation determination unit 30E may determine to continue stopping at the first stop position P1. Further, in a case where none of the weather, the air temperature, the stopping place, and the stopping time zone indicated by the situation information match the predetermined condition corresponding to the type of the product G loaded on the mobile body 20, the stop continuation determination unit 30E may determine not to continue stopping at the first stop position P1.

In addition, the stop continuation determination unit 30E may acquire, as situation information, event information around the first stop position P1 of the mobile body 20 from the management device 10 or the like, and determine whether the current position or the current date and time of the mobile body 20 is a place or a time zone in which the demand for the product G is expected due to the event indicated by the event information based on the event information. Then, in a case where the current position or the current time of the mobile body 20 is a place or a time zone in which the demand for the product G is expected by the event indicated by the event information, the stop continuation determination unit 30E may determine to continue stopping at the first stop position P1.

In a case where the situation information indicates the stop instruction by the first user C1 or the stop instruction by the second user C2 other than the first user C1, the stop continuation determination unit 30E may determine to continue stopping at the first stop position P1. In a case where the situation information does not indicate the stop instruction by the first user C1 or the stop instruction by the second user C2 other than the first user C1, the stop continuation determination unit 30E may determine not to continue stopping at the first stop position P1.

For example, after the operation of selling to the first user C1 ends, the first user C1, the second user C2 acting together with the first user C1, or the second user C2 around the first user C1 may desire to continuously purchase the product G.

Therefore, the stop continuation determination unit 30E detects a stop instruction by the first user C1 or a stop instruction by the second user C2. For example, when a stop continuation button is displayed on the output unit 23, and the operation of the stop continuation button is instructed by the first user C1 or the second user C2 operating the input unit 22, the stop continuation determination unit 30E detects a stop instruction by the first user C1 or the second user C2. Further, the stop continuation determination unit 30E may detect the stop instruction by the first user C1 or the second user C2 when detecting that the predetermined gesture indicating the stop instruction by the first user C1 or the second user C2 is performed by analyzing the captured image around the mobile body 20 acquired by the sensor 24. Further, when the stop instruction is input by the operation of the information processing terminal 18 by the first user C1 or the second user C2 and the stop instruction is received from the information processing terminal 18, the stop continuation determination unit 30E may detect the stop instruction by the first user C1 or the second user C2.

Then, in a case of detecting the stop instruction, the stop continuation determination unit 30E may determine to continue stopping at the first stop position P1.

Further, for example, in a case where a change in the situation around the mobile body 20 from the stop at the first stop position P1 to the end of the selling operation indicated by the situation information, is equal to or greater than the threshold value, the stop continuation determination unit 30E determines to continue stopping at the first stop position P1.

The change in the situation around the mobile body 20 from the stop at the first stop position P1 to the end of the selling operation is, for example, a change in the number of users C present around the mobile body 20 in the period from the stop at the first stop position P1 to the end of the selling operation.

In this case, the stop continuation determination unit 30E may analyze the captured image or the like of the surroundings of the mobile body 20 acquired by the sensor 24, and may determine to continue stopping at the first stop position P1 in a case where the change in the number of users C present around the mobile body 20 in the period from the stop at the first stop position P1 to the end of the selling operation indicates an increase equal to or more than the threshold value. Further, in a case where a change in the number of users C present around the mobile body 20 in the period from the stop at the first stop position P1 to the end of the selling operation indicates an increase or a decrease below the threshold value, the stop continuation determination unit 30E may determine not to continue stopping at the first stop position P1.

Next, the stop continuation control unit 30F will be described.

In a case where the stop continuation determination unit 30E determines to continue stopping, the stop continuation control unit 30F performs control so that the stop at the first stop position P1 is continued for a predetermined period. Then, in a case of determining the elapse of the predetermined period, the stop continuation control unit 30F determines to resume the movement of the mobile body 20.

The stop continuation control unit 30F may determine the predetermined period for which the stop is continued at the first stop position P1 as follows.

For example, the stop continuation control unit 30F controls the drive unit 25 so that the mobile body continues stopping at the first stop position P1 for a predetermined period from the end of the operation of selling to the first user C1. The predetermined period is, for example, three minutes or the like, but is not limited to this time. In addition, this predetermined period may be appropriately changeable by an operation instruction given to the input unit 22 by the administrator or the like.

Furthermore, the stop continuation control unit 30F may determine the predetermined period according to the inventory status of the product G loaded on the mobile body 20. For example, the stop continuation control unit 30F may set the predetermined period to be longer as the inventory quantity of the products G loaded on the mobile body 20 is larger. Furthermore, the stop continuation control unit 30F may extend or shorten the predetermined period according to the inventory status of the product G loaded on the mobile body 20. For example, in a case where the stock of the product G decreases as the user C purchases many products G, the stop continuation control unit 30F may shorten the predetermined period.

In addition, in a case where the situation information indicates that another mobile body carrying another type of product G that is highly likely to be used together with the type of the product G loaded on the mobile body 20 is present within a predetermined distance, the stop continuation control unit 30F may change the predetermined period during which the stop is continued so as to match the stop period of the mobile body 20 to that of the other mobile body. For example, the stop continuation control unit 30F may change the predetermined period to match an earlier stop time limit or a later stop time limit among the stop time limits of the mobile body 20 and the other mobile body. Further, for example, the stop continuation control unit 30F may set a new same predetermined period for the mobile body 20 and the other mobile body.

In addition, the stop continuation control unit 30F may estimate a period during which the demand for the product G is high based on the event information or the like, and set the period as the predetermined period. For example, the stop continuation control unit 30F may set a period from 30 minutes before the event starts to 30 minutes after the event ends as the predetermined period.

Further, the stop continuation control unit 30F may set the predetermined period so that the stop is continued for a period in which the product G purchased by the first user C1 is included in the captured image captured by the imaging device that tracks the first user C1.

Further, for example, the stop continuation control unit 30F may control the drive unit 25 so that the mobile body continues stopping at the first stop position P1 for a predetermined period from the end of the operation of selling to the first user C1 until the second user C2 other than the first user C1 cannot be detected around the mobile body 20. The stop continuation control unit 30F may analyze the captured image acquired by the sensor 24 to determine whether the second user C2 who is the user C other than the first user C1 cannot be detected around the mobile body 20.

Further, for example, the stop continuation control unit 30F may control the drive unit 25 so that the mobile body continues stopping at the first stop position P1 for a predetermined period from the end of the operation of selling to the first user C1 until the number of second users C2 other than the first user C1, the second users C2 being present around the mobile body 20, is less than a predetermined value. The predetermined value may be determined in advance. The stop continuation control unit 30F may determine the number of second users C2 other than the first user C1, the second users C2 being present around the mobile body 20, by analyzing the captured image acquired by the sensor 24.

Furthermore, for example, the stop continuation control unit 30F may set a longer predetermined time as the number of second users C2 other than the first user C1, the second users C2 being present around the mobile body 20, at the end of the operation of selling to the first user C1 is larger.

Further, for example, the stop continuation control unit 30F may periodically count the number of second users C2 other than the first user C1, the second users C2 being present around the mobile body 20, and extend or shorten the initially set predetermined time according to the increase or decrease in the counted number of persons. For example, the stop continuation control unit 30F may extend the predetermined time in a case where the counted number of persons increases, and may shorten the predetermined time in a case where the counted number of persons decreases. In addition, the stop continuation control unit 30F may change the period to be extended or shortened according to the degree of increase or decrease in the counted number of persons. For example, the stop continuation control unit 30F may shorten or extend the predetermined time by a longer period as the degree of increase or decrease is larger.

Further, for example, the stop continuation control unit 30F may control the drive unit 25 so that the mobile body continues stopping at the first stop position P1 for a predetermined period from the end of the operation of selling to the first user C1 until the second user C2 having the attribute of the sales eligible target or the sales recommendation target other than the first user C1 cannot be detected around the mobile body 20.

Further, for example, the stop continuation control unit 30F may control the drive unit 25 so that the mobile body continues stopping at the first stop position P1 for a predetermined period from the end of the operation of selling to the first user C1 until the number of second users C2 having the attribute of the sales eligible target or the sales recommendation target other than the first user C1 is less than a predetermined value around the mobile body 20. The predetermined value may be determined in advance. The stop continuation control unit 30F may analyze the captured image acquired by the sensor 24 to determine the number and the attribute of second users C2 other than the first user C1, the second users C2 being present around the mobile body 20.

Note that the surroundings of the mobile body 20 may be either an imaging range by the imaging device included in the sensor 24 or a range within a predetermined distance from the sensor 24 within the imaging range.

In addition, in a case where the operation of selling to a new second user C2 other than the first user C1 is executed in a period from the end of the operation of selling to the first user C1 to the determination of the elapse of the predetermined period, the stop continuation control unit 30F may extend the predetermined time by the predetermined period.

Further, in a case of receiving the call request information from another mobile body, the information processing terminal 18, or the management device 10 in a period from the end of the operation of selling to the first user C1 until the elapse of the predetermined period is determined, the stop continuation control unit 30F may end the stop continuation at the first stop position P1 before the predetermined period elapses. The call request information is the same as described above, and is the call request information received directly from the information processing terminal 18 or from the information processing terminal 18 via the management device 10 when the second user C2 present at another point operates the information processing terminal 18.

In a case of determining the elapse of the predetermined period, the stop continuation control unit 30F determines to resume the movement of the mobile body 20.

In a case of determining the elapse of the predetermined period, the stop continuation control unit 30F may output information indicating movement resumption to the output unit 23. For example, the stop continuation control unit 30F may cause the output unit 23 to display information indicating movement resumption such as "The movement will be resumed soon" or output a voice of the information. In addition, in a case of determining that the predetermined period has elapsed and determining that the user C is present within a predetermined distance from the mobile body 20, the stop continuation control unit 30F may output information indicating movement resumption to the output unit 23.

Further, in a case where the elapse of the predetermined period is determined, the stop continuation control unit 30F may output, to the output unit 23, response method information indicating a method of responding to the user C in a case where the user C desires to extend the stop. For example, the stop continuation control unit 30F may cause the output unit 23 to display the response method information such as "Touch the screen in a case where you desire to make a purchase" or output a voice.

In addition, in a case where the stop continuation determination unit 30E determines to continue stopping, the stop continuation control unit 30F may perform control to output, to the output unit 23, information indicating how long the stop is continued or when the movement is started. In addition, in a case where the stop period is extended or shortened, the stop continuation control unit 30F may perform control to output, to the output unit 23, at least one of information indicating that the stop period is extended or shortened and information indicating the period that is extended or shortened. In addition, the stop continuation control unit 30F may count up or count down the information indicating the period according to the elapsed time and display the information on the output unit 23.

When it is determined that the predetermined period has elapsed, the movement control unit 30A controls the drive unit 25 so that the mobile body resumes the autonomous traveling of the mobile body 20 along the route R.

Therefore, after the operation of selling to the first user C1 is ended, the mobile body 20 continues the stop at the first stop position P1 according to the situation information about the mobile body 20, and resumes the autonomous traveling along the route R when the predetermined time elapses.

Note that, in a case where the operation of selling to the first user C1 is ended, and the purchase information about the product G by the first user C1 or the second user C2 that is another user C other than the first user C1 is received while the mobile body 20 continues stopping at the first stop position P1, the operation execution unit 30D may cause the selling operation unit 27 to execute the selling operation related to selling of the product G in the same manner as described above.

There is a case where purchase intention of the second user C2 is detected during autonomous movement of the mobile body 20 toward the first stop position P1.

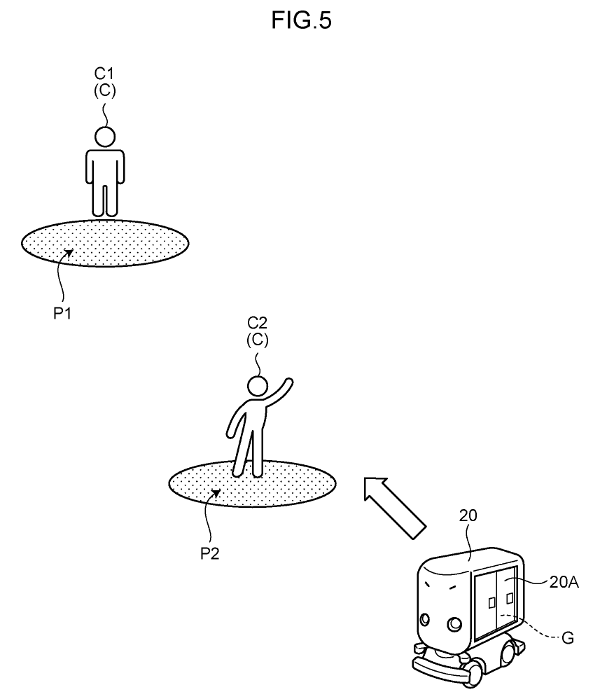

FIG. 5 is an explanatory diagram of an example of a scene where purchase intention of the second user C2 is detected while the mobile body 20 is autonomously moving toward the first stop position P1. The first stop position P1 may be a stoppable position around the first user C1 at the time of detecting the purchase intention of the first user C1 described above, or may be a position of a predetermined moving sales destination or the like.

In this case, in a case where the purchase intention of the second user C2 is detected by the detection unit 30B during the movement of the mobile body 20 to the first stop position P1 and the second stop position P2 is specified by the specification unit 30C, the movement control unit 30A may move the mobile body 20 to the second stop position P2 and stop the mobile body 20 in a case where the distance to the first stop position P1 is a predetermined distance or more.

In addition, in a case where the purchase intention of the second user C2 is detected by the detection unit 30B during the movement of the mobile body 20 to the first stop position P1 and the second stop position P2 is specified by the specification unit 30C, the movement control unit 30A moves the mobile body to the second stop position P2 and stops the mobile body. Then, in a case where the distance to the first stop position P1 is a predetermined distance or more, the movement control unit 30A may continue stopping at the second stop position P2. In this case, it is possible to suppress a loss of the sales opportunity around the second stop position P2. In a case where the distance to the first stop position P1 is less than the predetermined distance, the movement control unit 30A may perform control so that the mobile body does not continue stopping at the second stop position P2. In a case where the distance between the first stop position P1 and the second stop position P2 is less than the predetermined distance, the mobile body stops at the first stop position P1 at which the mobile body is scheduled to stop even if the mobile body does not continue stopping at the second stop position P2, whereby it is possible to suppress the loss of the sales opportunity around the first stop position P1 and the second stop position P2.

In a case where the distance to the first stop position P1 is less than the predetermined distance, the movement control unit 30A may inquire of the operator whether to change the first stop position P1 to the second stop position P2 instead of not continuing stopping at the second stop position P2. Then, in a case of obtaining a response indicating that the change is possible, the movement control unit 30A may perform control so that the mobile body continues stopping at the second stop position P2. In this case, the loss of the sales opportunity can be suppressed, and the mobile body 20 does not need to move from the second stop position P2 to the first stop position P1. In a case of obtaining a response indicating that the change is impossible, the movement control unit 30A may perform control so that the mobile body does not continue stopping at the second stop position P2.

The specification unit 30C specifies the second stop position P2 based on the position of the second user C2 as in the first stop position P1.

Then, in a case where the distance from the current position of the mobile body 20 to the first stop position P1 is a predetermined distance or more, the movement control unit 30A controls the drive unit 25 so that the mobile body 20 stops at the second stop position P2. Furthermore, in a case where the distance from the current position of the mobile body 20 to the first stop position P1 is less than the predetermined distance, the movement control unit 30A controls the drive unit 25 so that the mobile body 20 continues the movement toward the first stop position P1 without stopping at the second stop position P2.

In a case where the distance from the current position of the mobile body 20 to the first stop position P1 is less than a predetermined distance, that is, in a case where the distance is short, it is considered that there is no change in the sales opportunity even in a case where the mobile body stops at the second stop position P2, or even in a case where the mobile body passes through the second stop position P2 without stopping at the second stop position P2 and stops at the first stop position P1. In addition, in a case where the first stop position P1 is a position of a predetermined moving sales destination, the first stop position P1 is considered to be a sales position set by the management device 10 or the like. Therefore, in a case where the distance from the current position of the mobile body 20 to the first stop position P1 is less than the predetermined distance, the movement control unit 30A controls the drive unit 25 so that the mobile body 20 continues the movement toward the first stop position P1 without stopping at the second stop position P2, whereby deterioration of the sales efficiency can be suppressed.

In addition, in a case of controlling the drive unit 25 so that the mobile body stops at the second stop position P2, the movement control unit 30A may transmit inquiry information for inquiring whether to stop at the second stop position P2 to an information processing device operated by a remote operator.

The remote operator is a user who performs an operation for remotely controlling the mobile body 20, and performs an operation for remotely controlling the mobile body 20 by operating an information processing device such as the management device 10. In the present embodiment, a mode in which a remote operator operates the management device 10 will be described as an example. Note that the remote operator may remotely control the mobile body 20 by operating the information processing terminal operated by the remote operator.

The control unit 15 of the management device 10 that has received the inquiry information outputs the inquiry information to the output unit 13 of the management device 10. The remote operator who has confirmed the inquiry information output to the output unit 13 operates the input unit 12 to input a determination result indicating whether to permit the stop at the second stop position P2. The control unit 15 of the management device 10 transmits response information indicating the received determination result to the mobile body 20 that is the transmission source of the inquiry information. In a case where the response information received from the management device 10 indicates that the stop at the second stop position P2 is permitted, the movement control unit 30A of the mobile body 20 may control the drive unit 25 so that the mobile body 20 stops at the second stop position P2. In a case where the response information received from the management device 10 indicates that the stop at the second stop position P2 is not permitted, the movement control unit 30A may control the drive unit 25 so that the mobile body continues the movement toward the first stop position P1 without stopping at the second stop position P2.

In addition, in a case of controlling the drive unit 25 so that the mobile body 20 stops at the second stop position P2, the movement control unit 30A may determine the stop period at the second stop position P2 so that the mobile body can reach the first stop position P1 at the estimated time of arrival at the first stop position P1.

In addition, in a case of controlling the drive unit 25 so that the mobile body 20 stops at the second stop position P2, the movement control unit 30A may transmit, to the management device 10, inquiry information inquiring whether another mobile body can move to the scheduled first stop position P1 as a proxy. In a case where the control unit 15 of the management device 10 receives the inquiry information and determines that another mobile body mobile to the first stop position P1 is present, the control unit 15 transmits call request information including the position information of the first stop position P1 and the request signal for calling the other mobile body to the other mobile body. Furthermore, in this case, the management device 10 may transmit response information indicating that another mobile body is mobile as a proxy to the mobile body 20 that is the transmission source of the inquiry information. In a case where the response information indicating that another mobile body is mobile as a proxy to the first stop position P1 is received, the movement control unit 30A may control the drive unit 25 so that the mobile body does not move to the first stop position P1 after stopping at the second stop position P2 but to continue stopping at the second stop position P2.

Note that, in the above description, the case where the purchase intention of the second user C2 is detected while the mobile body 20 is autonomously moving toward the first stop position P1 is described. However, the above processing can also be applied to a case where it is necessary to move toward the second stop position P2 of the second user C2, who is another user C, after the mobile body stops at the first stop position P1 of the first user C1 and ends the selling operation due to detection of the purchase intention of the first user C1. The case where it is necessary to move toward the second stop position P2 of the second user C2 is a case where call request information is received from the information processing terminal 18 of the second user C2.

Note that, in a case of controlling the drive unit 25 so that the mobile body resumes movement after stopping at each of the first stop position P1 and the second stop position P2, the mode is not limited to a mode in which the movement control unit 30A controls the drive unit 25 so that the mobile body returns to the predetermined route R and autonomously travels.

For example, the movement control unit 30A may control the drive unit 25 so that the mobile body autonomously travels while changing the traveling route so as to be in a direction along the moving direction of the user C who has purchased the product G. In this case, for example, the movement control unit 30A may identify the moving direction of the user C who has purchased the product G by tracking the captured image acquired by the sensor 24, and may control the drive unit 25 so that the mobile body autonomously travels along the moving direction. The advertising effect can be enhanced by the movement control unit 30A changing the traveling route so as to be in the direction along the moving direction of the user C.

In addition, the movement control unit 30A may change the route according to the battery status of the mobile body 20. For example, in a case where the battery status of the mobile body 20 is less than a predetermined amount, the movement control unit 30A may control the drive unit 25 so that the mobile body 20 travels toward the charging station.

Furthermore, the movement control unit 30A may control the drive unit 25 so that the mobile body 20 changes the route based on the situation around the mobile body 20. In this case, the movement control unit 30A may control the drive unit 25 so that the mobile body 20 travels in a direction in which the predetermined number or more of users C are present around the mobile body 20 by analyzing the captured image or the like acquired by the sensor 24.

In addition, the movement control unit 30A may control the drive unit 25 so that the mobile body changes the route based on a route change instruction by a remote operator or the like who operates the management device 10. For example, the movement control unit 30A transmits inquiry information indicating a confirmation request for route change to the management device 10 before resuming movement after the mobile body stops at each of the first stop position P1 and the second stop position P2. In a case of instructing the route change, the remote operator operating the management device 10 inputs the route change instruction and the response information indicating the changed route by operating the input unit 22. The management device 10 transmits the received response information to the mobile body 20. In a case where the response information received from the management device 10 indicates the route change instruction, the movement control unit 30A of the mobile body 20 may control the drive unit 25 so that the mobile body 20 travels on the changed route indicated by the response information.

In addition, the movement control unit 30A may transmit inquiry information indicating a desire to change the route determined by the mobile body 20 to the management device 10 before resuming the movement after the mobile body stops at each of the first stop position P1 and the second stop position P2. In this case, in a case of permitting the route change, the remote operator operating the management device 10 inputs response information indicating the route change permission by operating the input unit 22. The management device 10 transmits the received response information to the mobile body 20. In a case where the response information received from the management device 10 indicates the route change permission, the movement control unit 30A of the mobile body 20 may control the drive unit 25 so that the mobile body 20 travels on the changed route determined by the mobile body 20.

In addition, in a case of resuming the movement from the state of stopping at the first stop position P1 or the second stop position P2, the movement control unit 30A may control the drive unit 25 so that the mobile body slows down at a speed lower than a predetermined speed for a predetermined time or a predetermined distance from the time of resuming the movement. The speed at the time of the slowdown may be lower than the moving speed when the mobile body 20 goes around the route R by moving sales.

Note that, in a period in which the mobile body 20 continues stopping at the first stop position P1 or the second stop position P2, the operation execution unit 30D may further perform an operation for prompting sales of the product G.

Specifically, the operation execution unit 30D may perform control to output the advertisement information about the product G loaded on the mobile body 20 to the output unit 23. Furthermore, the operation execution unit 30D may perform control to output information indicating that the product G is on sale to the output unit 23. Furthermore, the operation execution unit 30D may control the mobile part of the mobile body 20 so as to perform a predetermined operation for appealing for the product G loaded on the mobile body 20. Further, the operation execution unit 30D may execute different operations according to the remaining period of the stop continuation. For example, the operation execution unit 30D may perform control to output the advertisement information of the product G to the output unit 23 in a case where the remaining period is sufficient, and perform control to output alert information indicating that the movement is resumed soon to the output unit 23 in a case where the remaining period is short. In addition, as described above, since the remaining period of the stop continuation changes according to the extension or shortening of the stop period, the operation execution unit 30D may execute different operations according to the changing remaining period of the stop continuation.

Furthermore, in a case where the user C purchases the product G in the stop period of the mobile body 20, the operation execution unit 30D may perform control to output, to the output unit 23, appeal information for appealing to the surroundings of the mobile body 20 for moving sales. The timing of outputting the appeal information to the output unit 23 may be either during or immediately after the purchase of the product G by the user C, or may be both. By performing the output control, it is possible to notify the user present at a position slightly away from the mobile body 20 that the mobile body 20 is on moving sale. Specifically, for example, the operation execution unit 30D may perform control so that the output unit 23 outputs voice information such as "Thank you for your purchase" as the appeal information after the user C purchases the product G. Furthermore, in the appeal information, the information indicating that the product is being sold in a moving manner may include the content of an utterance or the like that attracts surrounding people. By outputting such appeal information, the user around the mobile body 20 can easily recognize that the mobile body 20 is executing the moving sales.

Furthermore, the operation execution unit 30D may control the drive unit 25 so that the mobile body 20 rotates on the spot in a case where the user C purchases the product G in the stop period of the mobile body 20. Depending on the configuration of the mobile body 20, there is a case in which what product is sold can be recognized from the situation of the surroundings when viewing from one side (for example, the left side) of the mobile body 20, but what product G is sold cannot be recognized from the situation of the surroundings when viewing from the other side (for example, the right side, the front, the rear, and the like). Therefore, when the operation execution unit 30D performs the control, it is possible to eliminate the above problem and promote a sales opportunity. At this time, the operation execution unit 30D may also output the appeal information to the output unit 23.

In addition, the operation execution unit 30D may execute the limited-time sale of the product G in a case where the remaining time of the stop period is short (for example, the remaining time of 10 minutes). With this processing, it is possible to further increase the purchase desire of the surrounding users C.

In the above description, a mode is described in which the stop continuation determination unit 30E determines whether to continue stopping at the first stop position P1 based on the situation information detected by the sensor 24, the selling operation unit 27, and the like that are mounted on the mobile body 20.

However, the stop continuation determination unit 30E may determine whether to continue stopping at the first stop position P1 based on the situation information indicated by the operation instruction by the remote operator outside the mobile body 20.

In this case, for example, when the operation of selling to the first user C1 ends, the stop continuation determination unit 30E transmits, to the management device 10 operated by the remote operator, inquiry information requesting determination as to whether it is necessary to continue stopping.

At this time, the stop continuation determination unit 30E may transmit inquiry information including determination support information for supporting the determination by the remote operator as to whether to continue stopping. The determination support information is, for example, a captured image of the surroundings of the mobile body 20, a distance to the user C present around the mobile body 20, information about the product G purchased by the user C, an attribute of the user C present around the mobile body 20, weather and air temperature around the mobile body 20, a type of the product G loaded on the mobile body 20, inventory information of the product G loaded on the mobile body 20, information about another mobile body present around the mobile body 20, or the like, which is acquired by the sensor 24.

Note that, in a case where the information processing device operated by the remote operator is another information processing device other than the management device 10, at least part of the information may be transmitted from the management device 10 to the information processing device operated by the remote operator. In this case, an example of the determination support information transmitted from the management device 10 to the information processing device operated by the remote operator includes past sales record information in the same area as the first stop position P1 at which the mobile body stops at the end of the selling operation. The past sales record information preferably has a configuration in which the condition can be changed. For example, the past sales record information may be past sales record information about conditions such as the same area as the first stop position P1, the same time zone as the time zone at which the mobile body stops, and the same product classification as the sold product G.

As described above, in the present embodiment, a description will be given assuming that a remote operator operates the management device 10.

When a determination result as to whether to continue stopping is input according to an operation instruction given to the input unit 12 by the remote operator, the control unit 15 of the management device 10 operated by the remote operator transmits response information including the determination result to the mobile body 20. In a case where the response information received from the management device 10 operated by the remote operator indicates that the stop is continued, the stop continuation determination unit 30E of the mobile body 20 may determine to continue stopping at the first stop position P1.

In addition, the stop continuation determination unit 30E may transmit, to the management device 10 operated by the remote operator, inquiry information requesting determination as to whether it is necessary to continue stopping when determining to continue stopping at the first stop position P1 instead of when the operation of selling to the first user C1 is ended. In a case where the mobile body 20 transmits, to the management device 10, inquiry information requesting determination as to whether it is necessary to continue stopping each time the selling operation is terminated, the frequency of transmission of the inquiry information to the management device 10 increases, and the burden on the remote operator may increase. Therefore, when determining to continue stopping at the first stop position P1, the inquiry information requesting determination as to whether it is necessary to continue stopping is transmitted to the management device 10 operated by the remote operator, whereby the burden on the remote operator can be reduced.

In addition, the stop period may be designated by a remote operator. In this case, the control unit 15 of the management device 10 operated by the remote operator displays a screen for receiving designation of the stop period on the output unit 13. Further, in a case where the purchase intention of the second user C2 is detected while the mobile body 20 is autonomously moving toward the first stop position P1, and the estimated time of arrival at the first stop position P1 is set, the estimated time of arrival or the stoppable time determined by the estimated time of arrival may be further displayed on the screen as the reference information. Note that the present invention is not limited to the case where the mobile body 20 is autonomously moving toward the first stop position P1. Even in a case where the mobile body is autonomously moving toward a destination such as a preset sales stop scheduled position and there is a time limit of arrival at the destination, a stoppable time determined by the arrival time limit may be further displayed on the screen as reference information.

The control unit 15 may calculate the stoppable time by calculating "(period from current time to estimated time of arrival) - (period required for movement from stop position to destination)". In addition, in a case of detecting purchase intention of the user C while moving from the stop position to the destination, the control unit 15 may calculate the stoppable time in consideration of a margin of the period.

Furthermore, the control unit 15 of the management device 10 operated by the remote operator may perform input restriction so that a time within the stoppable time represented by the estimated time of arrival can be accepted as the stop period. In addition, in a case where the stop period input by the remote operator exceeds the stoppable time, the control unit 15 of the management device 10 operated by the remote operator may output alert information to the output unit 13 and further output information prompting input of less than the stoppable time to the output unit 13.

In this case, the control unit 15 of the management device 10 operated by the remote operator transmits, to the mobile body 20, response information including a determination result as to whether to continue stopping and a stop period in a case of representing the determination result of continuing stopping. In a case where the response information received from the management device 10 operated by the remote operator indicates that the stop is continued, the stop continuation determination unit 30E of the mobile body 20 may determine to continue stopping at the first stop position P1 for the stop period included in the response information. Then, the movement control unit 30A may control the drive unit 25 so that the stop is continued at the first stop position P1 during the stop period.

The stop position may be designated by a remote operator. For example, there is a case where the remote operator desires to continue stopping but desires to continue stopping the mobile body 20 at a position moved from the current stop position. Specifically, in a case where the current stop position of the mobile body 20 is a place that obstructs passage of another moving object in a case where the current stop position is a place that is difficult for the user C to visually recognize, or the like, the remote operator may desire to designate the stop position.

In this case, the control unit 15 of the management device 10 operated by the remote operator displays a screen for receiving the designation of the stop position on the output unit 13. For example, the control unit 15 of the management device 10 operated by the remote operator displays a map screen including the current position of the mobile body 20 on the output unit 13. The remote operator operates the input unit 12 while visually recognizing the image displayed on the output unit 13, thereby designating the stop position at which the stop is desired. At this time, the control unit 15 may be able to perform control so that the position can be adjusted within a predetermined range from the current stop position. Specifically, the control unit 15 may perform control so as to set a limit on a range where the position can be designated on the image by the remote operator.

The control unit 15 of the management device 10 that has received the designation of the stop position transmits, to the mobile body 20, response information including the determination result as to whether to continue stopping and designated stop position information. In a case where the response information received from the management device 10 operated by the remote operator indicates that the stop is continued, the stop continuation determination unit 30E of the mobile body 20 determines to continue stopping. Then, after controlling the drive unit 25 so that the mobile body moves to the stop position indicated by the stop position information included in the response information, the stop continuation control unit 30F may control the drive unit 25 so that the mobile body continues stopping at the position. In addition, control may be performed so that the mobile body 20 is stopped at a stop position desired by the remote operator by remote driving of the mobile body 20 by the remote operator.

Furthermore, in a case where it is detected that road-parked vehicle stops around the mobile body 20 while the mobile body continues stopping and it is difficult for the mobile body to be visually recognized from the surroundings, the mobile body 20 may automatically move to a position where the mobile body is easily visually recognized from the surroundings. In addition, the mobile body 20 may be configured to suspend the stop continuation and resume the movement instead of moving to a position that is easily visually recognized. In addition, the mobile body 20 may be moved to a position where it is easy to visually recognize by an operation instruction by a remote operator. For example, a scene is assumed in which a sensor mounted in the mobile body 20 detects an object of a predetermined size or more around the mobile body 20, and the mobile body 20 is hardly visually recognized from the surroundings. In this case, the mobile body 20 may output information prompting the remote operator to move to a position where it is easy to visually recognize. In a case where a movement instruction is given by the remote operator, the mobile body 20 may move to a position that is easily visually recognized from the surroundings.

In a case where the stop continuation determination unit 30E determines to continue stopping at the first stop position P1 and the movement control unit 30A starts the stop continuation, the configuration may be provided that allows the remote operator to monitor the situation around the mobile body 20 in the stop continuation.

In this case, in a case of determining to continue stopping, the movement control unit 30A of the mobile body 20 transmits, to the management device 10, the captured image of the surroundings of the mobile body 20 acquired by the sensor 24. The control unit 15 of the management device 10 may display a monitoring screen including the received captured image on the output unit 13. By displaying the monitoring screen on the output unit 13, in a case where the situation around the mobile body 20 changes, the remote operator can determine and instruct the operation of the extension or suspension of the stop continuation. Therefore, it is possible to improve sales efficiency.

The remote operator who has viewed the monitoring screen may determine, for example, that a nearby user may be trying to use the mobile sales, and may determine the extension of the stop continuation.

In addition, the control unit 15 may superimpose and display, on the monitoring screen, information of determination support for the remote operator to determine that the nearby user may be trying to use the mobile sales. The information about the determination support is, for example, information indicating that there is a person approaching the mobile body 20, information indicating that a person around the mobile body 20 continuously directs his/her line of sight toward the mobile body 20 for a predetermined period of time, information indicating that a total period of time during which a person around the mobile body 20 directs his/her line of sight toward the mobile body 20 is equal to or longer than a predetermined period, information indicating that there is a user who is making a predetermined gesture (for example, beckoning) toward the mobile body 20, or the like. In addition, the control unit 15 may superimpose and display two or more of these pieces of information on the monitoring screen.

The control unit 15 may determine whether there is a person approaching the mobile body 20 based on a detection result by a distance measurement sensor or the like provided in the mobile body 20, and may perform superimposition display on the monitoring screen in a case where it is determined that there is the person approaching the mobile body 20. In addition, the control unit 15 may determine whether a person around the mobile body 20 is continuously directing his/her line of sight toward the mobile body 20 for a predetermined period using the captured video of the surroundings of the mobile body 20 captured by the mobile body 20, and may superimpose and display information indicating that the line of sight is directed on the monitoring screen in a case where it is determined that the line of sight is directed. In addition, the control unit 15 may determine whether a total period during which a person around the mobile body 20 directs his/her line of sight toward the mobile body 20 is equal to or longer than a predetermined period using the captured video of the surroundings of the mobile body 20 captured by the mobile body 20, and may superimpose and display, on the monitoring screen, information indicating that the total period during which the line of sight is directed is equal to or longer than the predetermined period in a case where it is determined that the total period is equal to or longer than the predetermined period. In addition, the control unit 15 may determine whether there is a user who is making a predetermined gesture toward the mobile body 20 using the captured video of the surroundings of the mobile body 20 captured by the mobile body 20, and in a case where it is determined that there is a user who is making a predetermined gesture toward the mobile body 20, may superimpose and display information indicating that there is a user who is making a predetermined gesture toward the mobile body 20 on the monitoring screen.

In addition, the control unit 15 may superimpose and display, on the monitoring screen, not only the information about the determination support, but also information inquiring whether to extend the stop continuation (departure start), and the like.

Note that the control unit 15 may superimpose and display the information on the monitoring screen not only in a case of continuing stopping, but also at any timing as long as the operator remotely monitors the mobile body 20. For example, the control unit 15 can support the remote operator in determining whether it is necessary to stop the mobile body 20 by superimposing and displaying the information about the determination support on the monitoring screen while the mobile body 20 is moving.

In addition, the control unit 15 may be configured to stop the mobile body 20 instead of superimposing and displaying the information about the determination support on the screen monitored by the remote operator. For example, in a case where a distance measurement sensor or the like provided in the mobile body 20 detects a person approaching the mobile body 20, the control unit 15 may perform control to stop the mobile body 20. In addition, the control unit 15 may perform control to stop the mobile body 20 in a case where it is detected that a person around the mobile body 20 continuously directs his/her line of sight toward the mobile body 20 for a predetermined period, a total period during which a person around the mobile body 20 directs his/her line of sight toward the mobile body 20 is equal to or longer than a predetermined period, there is a user making a predetermined gesture toward the mobile body 20, or the like, using the captured video captured by the mobile body 20.

In addition, the monitoring screen may include an input field capable of designating at least one of extension, shortening, and suspension of the stop continuation. In addition, the monitoring screen may further include an input field capable of designating the extension period via the input field in a case where the remote operator desires to extend the stop continuation. In addition, in a case where the trigger for extending or shortening the stop continuation is determined by the mobile body 20, the determination result may be transmitted from the mobile body 20 to the management device 10. In a case where the determination result is received, the control unit 15 of the management device 10 may be configured to display, on the output unit 13, a screen prompting the remote operator to determine whether the extension or the shortening is necessary, and receive an input of the determination as to whether the extension or the shortening is necessary by the remote operator. At this time, the configuration may be provided allowing the remote operator to designate the extension period or the shortening period.

In addition, the monitoring screen may include an input field in which the departure can be designated instead of the suspension of the stop continuation. In addition, a configuration may be provided allowing a remote operator to designate the timing of departure or suspension without determining a period for stopping the mobile body.

In a case where the stop continuation determination unit 30E determines whether to continue stopping at the first stop position P1 based on the situation information other than the operation instruction by the remote operator, the mobile body may stop at the first stop position P1 for a long period of time.

For example, in a case where an event for extending the stop continuation such as purchase of the product G by a new second user C2 occurs continuously at the first stop position P1, the mobile body may stop at the first stop position P1 for a long period of time.

In a case where the mobile body 20 stops at the first stop position P1 for a long period of time, a behavior deviating from the original purpose of selling the product G while going around the route R is exhibited, and the sales efficiency may deteriorate. Specifically, in a case where the frequency of purchase of the product G by the new second user C2 is lower than the frequency of purchase of the product G in a case where the user moves to another place, the sales efficiency deteriorates.

Therefore, in a case where the stop continuation is extended and the stop at the first stop position P1 is continued for a predetermined period or longer, the stop continuation determination unit 30E may transmit, to the management device 10, inquiry information as to whether to extend the stop continuation. The control unit 15 of the management device 10 outputs the inquiry information to the output unit 13. The remote operator operating the management device 10 operates the input unit 12 to input a determination result as to whether to continue stopping based on the inquiry information. The control unit 15 transmits, to the mobile body 20, response information including the determination result having received the input. The stop continuation determination unit 30E of the mobile body 20 may determine to continue stopping at the first stop position P1 in a case where the response information indicates the stop continuation. Further, in a case where the response information indicates that the stop is not continued, the stop continuation determination unit 30E may determine not to continue stopping at the first stop position P1. Then, the movement control unit 30A may drive and control the drive unit 25 according to these determination results.

In addition, a configuration in which a limit is set to the extension period of the stop continuation is provided, and the stop continuation determination unit 30E may determine to stop the stop continuation in a case where the extension period is exceeded.

In addition, it is assumed that the stop continuation determination unit 30E determines to continue stopping at the first stop position P1 based on the situation information other than the operation instruction by the remote operator, and the movement control unit 30A controls the drive unit 25 so that the mobile body continues stopping at the first stop position P1 for a predetermined period or more. In this case, the stop continuation determination unit 30E may transmit inquiry information for confirming necessity of the stop continuation extension to the management device 10 before the predetermined period is reached, and prompt the determination of the stop continuation extension by the remote operator. Then, in a case where the response information indicating that the stop continuation extension is permitted by the operation instruction given to the input unit 12 by the remote operator is received from the management device 10, the stop continuation determination unit 30E may control the drive unit 25 so that the mobile body extends the predetermined period and continues stopping at the first stop position P1.

At this time, the stop continuation determination unit 30E may transmit inquiry information for confirming the necessity of the stop continuation extension including the determination support information to the management device 10. In addition, the stop continuation determination unit 30E may transmit, to the management device 10, determination support information further including the sales record of the product G during the continuous stop, a temporal change in the sales record of the product G during the continuous stop, and a change in the number of users C around the mobile body 20, as the determination support information. In this case, the remote operator can study whether to extend the stop continuation in consideration of the sales record of the product G, the increasing tendency of the user C around the mobile body 20, and the like.

Note that the timing at which the stop continuation determination unit 30E determines whether to continue stopping may be any timing in the period from the timing at which the purchase intention of the first user C1 is detected to the timing at which the mobile body 20 resumes the movement.

For example, the timing at which the stop continuation determination unit 30E determines whether to continue stopping is any of the timing at which the purchase intention of the first user C1 is detected and the stop is determined, the timing at which the mobile body 20 is stopped, the timing at which the input of the selection of the product G from the first user C1 is received, the timing at which the settlement process for the first user C1 is started, the timing at which the settlement process is ended, the timing at which the selling operation unit 27 completes preparation for the provision of the product G to the first user C1, the timing at which the first user C1 takes out the product G from the product outlet 20B, the timing at which the first user C1 who has purchased the product G is away from the mobile body 20 by a predetermined distance or more, and the timing at which the first user C1 who has purchased the product G is away from the mobile body 20 and is no longer detected in the image captured by the imaging device included in the sensor 24, the timing immediately before the movement control unit 30A resumes movement, a predetermined period after these timings, and the like.

Note that the starting point of the stop period during which the mobile body 20 continues stopping at the first stop position P1 is not limited to the timing of the end of the operation of selling to the first user C1 described above. The starting point of the stop period during which the mobile body 20 continues stopping at the first stop position P1 may be any timing of the period from the timing at which the purchase intention of the first user C1 is detected and the stop at the first stop position P1 is determined to the timing at which the mobile body 20 resumes movement.

For example, the starting point of the stop period during which the stop continuation determination unit 30E continues stopping is any of the timing at which the purchase intention of the user C is detected and the stop is determined, the timing at which the mobile body 20 is stopped, the timing at which the input of the selection of the product G from the first user C1 is received, the timing at which the settlement process for the first user C1 is started, the timing at which the settlement process is ended, the timing at which the selling operation unit 27 completes preparation for the provision of the product G to the first user C1, the timing at which the first user C1 takes out the product G from the product outlet 20B, the timing at which the first user C1 who has purchased the product G is away from the mobile body 20 by a predetermined distance or more, and the timing at which the first user C1 who has purchased the product G is away from the mobile body 20 and is no longer detected in the image captured by the imaging device included in the sensor 24, the timing immediately before the movement control unit 30A resumes movement, a predetermined period after these timings, and the like.

Next, an example of a flow of information processing executed by the control unit 30 of the mobile body 20 according to the present embodiment will be described.

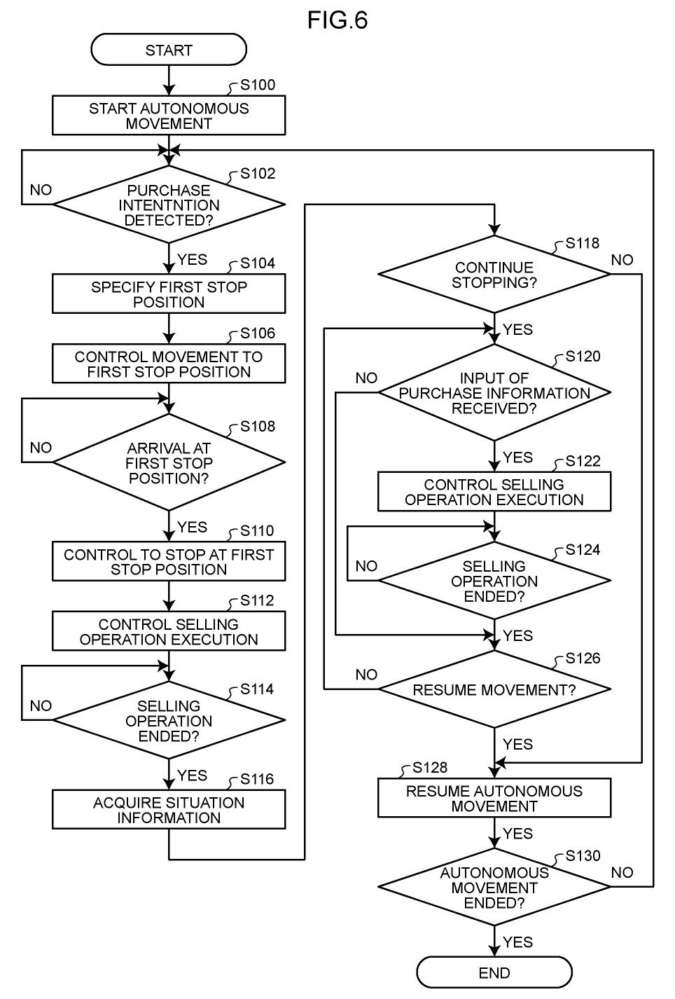

FIG. 6 is a flowchart illustrating an example of a flow of information processing executed by the control unit 30 of the mobile body 20 of the present embodiment.

The movement control unit 30A causes the drive unit 25 to autonomously move the mobile body 20, whereby the autonomous movement of the mobile body 20 along the route R is started (step S100).

The detection unit 30B repeats the negative determination (step S102: No) until it is determined that the purchase intention of the first user C1 is detected (step S102: Yes). When the detection unit 30B detects the purchase intention of the first user C1 (step S102: Yes), the specification unit 30C specifies the first stop position P1 at which the mobile body 20 is stopped (step S104).

The movement control unit 30A controls the drive unit 25 so that the mobile body moves toward the first stop position P1 specified in step S104 (step S106). Then, the movement control unit 30A determines whether the mobile body 20 has arrived at the first stop position P1 (step S108). The movement control unit 30A determines whether the position of the mobile body 20 detected by the sensor 24 matches the first stop position P1, thereby making the determination in step S108. The movement control unit 30A repeats the negative determination (step S108: No) until the affirmative determination is made in step S108 (step S108: Yes), and the process proceeds to step S110 when the affirmative determination is made (step S108: Yes). In step S110, the movement control unit 30A controls the drive unit 25 so that the mobile body stops at the first stop position P1 (step S110).

The operation execution unit 30D causes the selling operation unit 27 to execute the selling operation related to selling of the product G (step S112). By the process in step S112, the product G is sold to the first user C1.

Next, the stop continuation determination unit 30E determines whether the operation of selling to the first user C1 has ended (step S114). The stop continuation determination unit 30E repeats the negative determination (step S114: No) until the affirmative determination (step S114: Yes) is made in step S114, and when the affirmative determination is made (step S114: Yes), the process proceeds to step S116.

The stop continuation determination unit 30E acquires situation information about the mobile body 20 which is the host vehicle (step S116). Then, the stop continuation determination unit 30E determines whether to continue stopping at the first stop position P1 based on the situation information acquired in step S116 (step S118).

When determining not to continue stopping at the first stop position P1 (step S118: No), the process proceeds to step S128 described later. When determining to continue stopping at the first stop position P1 (step S118: Yes), the process proceeds to step S120.

In step S120, the operation execution unit 30D determines whether input of purchase information about the product G whose purchase is desired has been received from the second user C2 (step S120). When a negative determination is made in step S120 (step S120: No), the process proceeds to step S126 described later. When an affirmative determination is made in step S120 (step S120: Yes), the process proceeds to step S122.

In step S122, the operation execution unit 30D causes the selling operation unit 27 to execute the selling operation related to selling of the product G (step S122). The product G is sold to the second user C2 by the process in step S122.

Next, the stop continuation determination unit 30E determines whether the operation of selling to the second user C2 has ended (step S124). The stop continuation determination unit 30E repeats the negative determination (step S124: No) until the affirmative determination (step S124: Yes) is made in step S124, and when the affirmative determination (step S124: Yes) is made, the process proceeds to step S126.

Next, the stop continuation control unit 30F determines whether to resume the movement of the mobile body 20 (step S126). For example, the stop continuation control unit 30F determines whether a predetermined period has elapsed from the end of the operation of selling to the first user C1 determined by the affirmative determination in step S114, thereby making the determination in step S126. When a negative determination is made in step S126 (step S126: No), the process returns to step S120. When an affirmative determination is made in step S126 (step S126: Yes), the process proceeds to step S128.

In step S128, the movement control unit 30A controls the drive unit 25 so that the mobile body 20 resumes the autonomous traveling along the route R (step S128).

Next, the movement control unit 30A determines whether to end the autonomous movement of the mobile body 20 (step S130). For example, the movement control unit 30A determines whether a predetermined end time of the autonomous movement has come, thereby making the determination in step S130. Furthermore, the movement control unit 30A determines whether an instruction to end the autonomous movement has been received from the management device 10, thereby making the determination in step S130. When a negative determination is made in step S130 (step S130: No), the process returns to step S102. When an affirmative determination is made in step S130 (step S130: Yes), this routine is ended.

As described above, the mobile body control method of the present embodiment includes a mobile body control method executed by the control unit 30 (computer) that controls the mobile body 20 that autonomously moves and sells the product G (subject). A mobile body control method of the present embodiment includes a specification step of specifying a first stop position P1 at which the mobile body 20 is stopped, a movement control step of stopping the mobile body 20 at the first stop position P1, an operation execution step of executing a selling operation related to selling of the product G (subject) to the first user C1 when the mobile body stops at the first stop position P1, a stop continuation determination step of determining whether to continue stopping at the first stop position P1 based on situation information about the mobile body 20 at the end of the selling operation, and a stop continuation control step of controlling to continue stopping at the first stop position P1 when determining to continue stopping.

In the related art, when the operation of selling the subject to the user is ended, the movement of the mobile body is resumed without determining the stop continuation. For this reason, in the related art, sales opportunities to other users present around the stop position are lost, and sales efficiency may deteriorate.

On the other hand, the mobile body control method of the present embodiment includes, after the mobile body 20 is stopped at the first stop position P1 and the selling operation related to selling of the product G to the first user C1 is executed, determining whether to continue stopping at the first stop position P1 based on the situation information about the mobile body 20 at the end of the selling operation. Then, the mobile body control method of the present embodiment includes performing control so that the stop is continued at the first stop position P1 when it is determined that the stop is continued.

As described above, the mobile body control method of the present embodiment includes determining whether to continue stopping at the first stop position P1 based on the situation information about the mobile body 20 when the mobile body is stopped at the first stop position P1 and the operation of selling to the first user C1 is ended. Therefore, the mobile body control method of the present embodiment does not stop the mobile body 20 for the fixed period even though the sales opportunity is not obtained even if the stop is continued, and it is possible to suppress deterioration of the sales efficiency. In addition, the mobile body control method of the present embodiment includes determining whether to continue stopping based on the situation information when the mobile body is stopped at the first stop position P1 and the operation of selling to the first user C1 is ended. Therefore, it is possible to suppress a loss of an opportunity to sell to another user C present around the first stop position P1, and it is possible to suppress deterioration of sales efficiency.

Therefore, the mobile body control method of the present embodiment can suppress deterioration of sales efficiency.

In the above description, a mode in which the subject is the product G is described as an example. However, the mobile body control system 1 of the present embodiment is applicable to a case where the subject is a service for carrying a person. In this case, the purchase intention may be intention to use the mobile body 20 by the user C. Further, the first stop position P1 and the second stop position P2 may be positions where the mobile body 20 can stop around a position where the user C gets on or off the mobile body 20.

Furthermore, in the above description, a mode in which the stop continuation determination unit 30E determines whether to continue stopping at the first stop position P1 based on the situation information about the mobile body 20 when determining the end of the operation of selling to the first user C1 by the operation execution unit 30D is described as an example.

However, when determining the end of the operation of selling to the first user C1, the operation execution unit 30D of the control unit 30 of the mobile body 20 may control the drive unit 25 so that the mobile body 20 randomly travels in a range within a predetermined distance from the first stop position P1. The predetermined distance is, for example, 10 m or the like, but is not limited to this distance. Then, the operation execution unit 30D may perform control so as to output information appealing for the product G loaded on the mobile body 20 to the output unit 23 during a period in which the drive unit 25 is controlled so that the mobile body 20 travels randomly. The information for appealing for the product G may be, for example, information for encouraging customers to come to the product G, such as "Do you want the product G?".

The operation execution unit 30D controls the drive unit 25 so that the mobile body 20 randomly travels in a range within a predetermined distance from the first stop position P1 when determining the end of the operation of selling to the first user C1, so that it is possible to further improve the sales efficiency and suppress the loss of the sales opportunity.

Then, the stop continuation determination unit 30E may determine whether to continue stopping at the first stop position P1 or around the first stop position P1 based on the situation information about the mobile body 20 after the end of the period in which the operation execution unit 30D controls the drive unit 25 so that the mobile body travels randomly.

In the present embodiment, a mode is described in which the stop continuation determination unit 30E determines whether to continue stopping and continues stopping in a case where it is determined to continue stopping. However, the stop continuation determination unit 30E may perform control to stop the mobile body 20 at the stop position such as the first stop position P1 or the second stop position P2 for a fixed period without determining whether to continue stopping.

For example, in the case of the mobile body 20 that constantly travels in a crowded area, an operation of uniformly stopping the mobile body for a fixed period without determining whether it is necessary to continue stopping may be performed. In such a case, there is a high possibility that a sales opportunity is high no matter where the mobile body 20 stops.

Therefore, in a case where the mobile body 20 satisfies a predetermined condition such as that the mobile body 20 constantly travels in a busy area, the stop continuation determination unit 30E may perform control to stop the mobile body 20 at the stop position such as the first stop position P1 or the second stop position P2 for a fixed period without determining whether to continue stopping. Note that this condition and the fixed period may be appropriately changeable according to an operation instruction given to the input unit 12, the input unit 22, or the like by the user. Further, the stop continuation determination unit 30E may change the fixed period based on the situation information and the like. The change of the fixed period may be performed in the same manner as the extension of the stop continuation described above.

Next, an example of a hardware configuration of the management device 10, the information processing terminal 18, and the mobile body 20 according to the above embodiment will be described.

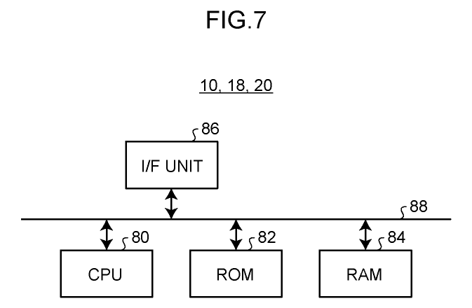

FIG. 7 is a hardware configuration diagram of an example of the management device 10, the information processing terminal 18, and the mobile body 20 of the embodiment.

The management device 10, the information processing terminal 18, and the mobile body 20 according to the above embodiment have a hardware configuration that includes a general computer and in which a central processing unit (CPU) 80, a read only memory (ROM) 82, a random access memory (RAM) 84, an I/F 86, and the like are connected to one another via a bus 88.

The CPU 80 is an arithmetic device that controls the management device 10, the information processing terminal 18, and the mobile body 20 of the above embodiment. The ROM 82 stores a program or the like that realizes information processing by the CPU 80. The RAM 84 stores data necessary for various processes by the CPU 80. The I/F86 is an interface connected to a storage unit, an input unit, an output unit, a sensor, a communication unit, and the like to transmit and receive data.

In the management device 10, the information processing terminal 18, and the mobile body 20 of the above embodiments, the CPU 80 reads the program from the ROM 82 onto the RAM 84 and executes the program, whereby the above functional units are realized on the computer.

Note that the program for executing each of the above-described processes executed by the management device 10, the information processing terminal 18, and the mobile body 20 of the above-described embodiments may be stored in a hard disk drive (HDD). In addition, the program for executing each of the above-described processes executed by the management device 10, the information processing terminal 18, and the mobile body 20 of the above-described embodiments may be provided by being incorporated in the ROM 82 in advance.

In addition, the program for executing the above-described processes executed by the management device 10, the information processing terminal 18, and the mobile body 20 according to the above-described embodiments may be stored in a computer-readable storage medium such as a CD-ROM, a CD-R, a memory card, a digital versatile disk (DVD), or a flexible disk (FD) as a file in an installable format or an executable format and provided as a computer program product. In addition, the program for executing the information processing executed by the management device 10, the information processing terminal 18, and the mobile body 20 of the above embodiment may be stored on a computer connected to a network such as the Internet and provided by being downloaded via the network. In addition, the program for executing the information processing executed by the management device 10, the information processing terminal 18, and the mobile body 20 of the above embodiments may be provided or distributed via a network such as the Internet.

Although the embodiment is described above, the embodiment has been presented as an example, and is not intended to limit the scope of the invention. This novel embodiment can be implemented in various other forms, and various omissions, substitutions, and changes can be made without departing from the gist of the invention. These embodiments and modifications thereof are included in the scope and gist of the invention, and are included in the invention described in the claims and the equivalent scope thereof.

For example, the control unit 18F of the information processing terminal 18 may display, on the output unit 18C, a display screen indicating at which position each of the plurality of mobile bodies 20 included in the mobile body control system 1 is stopped on the map. For example, the control unit 18F may display, on the output unit 18C, a display screen in which an icon image representing the mobile body 20 is disposed at a position corresponding to the mobile body position information about the mobile body 20 on a map image representing a map.

Furthermore, the control unit 18F of the information processing terminal 18 may further display information indicating whether the mobile body 20 being stopped displayed on the display screen is in the first stop state or the second stop state on the display screen.

The first stop state represents a stop state according to a schedule planned in advance. In a case of the first stop state, the mobile body 20 continues stopping until a predetermined time such as 30 minutes planned in advance elapses, for example.

The second stop state indicates a temporary stop continuation state to the first stop position P1 or the second stop position P2 by detection of purchase intention of the user C or the like described in the above embodiment. In the case of the second stop state, as described in the above embodiment, the mobile body 20 cancels the stop continuation and resumes movement according to the purchase intention of the user C or the like.

The control unit 18F of the information processing terminal 18 may acquire, from the management device 10, information indicating the stop position of the mobile body 20 included in the mobile body control system 1, whether the mobile body 20 is in the first stop state or the second stop state, and the like. Then, the control unit 18F of the information processing terminal 18 may generate the display screen and display the display screen on the output unit 18C using the information acquired from the management device 10.

Furthermore, the control unit 18F of the information processing terminal 18 may display, on the display screen, a button image that can call by designating the mobile body 20 on the display region of the mobile body 20 in the second stop state or in the vicinity of the display region. In this case, the user C who operates the information processing terminal 18 can input a request for a call of the mobile body 20 displayed on the display region of the button image or in the vicinity of the display region by operating the input unit 18B and operating the button image while viewing the display screen. When the button image is instructed to be operated, the control unit 18F of the information processing terminal 18 may transmit, to the management device 10, information about the request for calling the mobile body 20 displayed on the display region of the button image or near the display region. The process according to transmission of the call request information and the call request to the management device 10 may be executed as in the above embodiment.

Through the process, the user C who operates the information processing terminal 18 can designate and call a desired mobile body 20 which is in the second stop state and temporarily continues stopping among the plurality of mobile bodies 20 managed by the mobile body control system 1.

Furthermore, the control unit 18F of the information processing terminal 18 may further display the remaining stop period indicating how long the mobile body 20 in at least one stop state of the first stop state and the second stop state continues stopping in the display region of each mobile body 20 or in the vicinity of the display region. The control unit 18F of the information processing terminal 18 may acquire the remaining stop period of the management device 10 from the management device 10.

In addition, the control unit 18F of the information processing terminal 18 may further display information indicating which route R the mobile body 20 which is in the second stop state and temporarily continues stopping is scheduled to go along after resuming movement. The control unit 18F of the information processing terminal 18 may acquire, from the management device 10, the information indicating the route R that the mobile body 20 is scheduled to go along.

In addition, in a case where the mobile body 20 which is in the second stop state and temporarily continues stopping has extended the stop continuation, shortened the stop continuation, or suspended the stop continuation to resume the movement by the processing described in the above embodiment, the control unit 18F of the information processing terminal 18 may further display information indicating that the mobile body has extended the stop continuation, shortened the stop continuation, or suspended the stop continuation to resume the movement. The control unit 18F of the information processing terminal 18 may acquire the information from the management device 10.

Since the control unit 18F of the information processing terminal 18 outputs the display screen and the information to the output unit 18C, it is possible to provide the user C who operates the information processing terminal 18 with at which position the mobile body 20 is present and what state the mobile body 20 is in, in an easily grasped manner.

Further, in the above embodiment, a mode in which the mobile body 20 is stopped at the first stop position P1 of the user C when the purchase intention of the user C is detected, and the stop is continued at the first stop position P1 based on the situation information about the mobile body 20 at the end of the selling operation is described as an example. However, the first stop position P1 may be determined in advance. In this case, for the mobile body 20, the mobile body 20 may stop at the predetermined first stop position P1 regardless of whether the purchase intention of the user C is detected. Then, for the subsequent processing, as in the above embodiment, the mobile body 20 may execute processing similar to the above processing such as continuing stopping at the first stop position P1 based on the situation information about the mobile body 20 at the end of the selling operation.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

Note that the present technology can also have the following configurations.

(1) A mobile body control method executed by a computer configured to control a mobile body configured to autonomously move and sell a subject, the mobile body control method including:

a specification step of specifying a first stop position for stopping the mobile body;

a movement control step of stopping the mobile body at the first stop position;

an operation execution step of executing a selling operation related to selling of the subject to a first user when stopping at the first stop position;

a stop continuation determination step of determining whether to continue stopping at the first stop position based on situation information about the mobile body at an end of the selling operation; and

a stop continuation control step of performing control to continue stopping at the first stop position when determining to continue stopping.

(2) The mobile body control method according to (1), further including:

a detection step of detecting purchase intention of the first user, in which

the specification step includes

specifying a stoppable position around the first user as the first stop position when detecting the purchase intention.

(3) The mobile body control method according to (1) or (2), in which

the stop continuation determination step includes

determining whether to continue stopping at the first stop position in accordance with the situation information indicating a presence situation of a second user other than the first user present around the mobile body.

(4) The mobile body control method according to any one of (1) to (3), in which

the stop continuation determination step includes

determining to continue stopping at the first stop position in a case where an attribute of a second user other than the first user present around the mobile body indicated by the situation information includes at least one of a sales promotion target and a sales eligible target of the subject loaded on the mobile body.

(5) The mobile body control method according to any one of (1) to (4), in which

the stop continuation determination step includes

determining to continue stopping at the first stop position in a case where the subject purchased by the first user indicated by the situation information is a predetermined subject having an advertising effect for a second user other than the first user around the mobile body.

(6) The mobile body control method according to any one of (1) to (5), in which

the stop continuation determination step includes

determining to continue stopping at the first stop position in a case where at least one of a number of the subjects purchased by the first user and a purchase amount of the subject that is indicated by the situation information is greater than or equal to a predetermined value.

(7) The mobile body control method according to any one of (1) to (6), in which

the stop continuation determination step includes

determining to continue stopping at the first stop position in a case where the situation information indicates that another mobile body other than the mobile body in which at least some types of the subjects overlap is not present within a predetermined distance of the mobile body.

(8) The mobile body control method according to any one of (1) to (7), in which

the stop continuation determination step includes

determining to continue stopping at the first stop position in a case where a total number of other mobile bodies other than the mobile body present within a predetermined range including the first stop position of the mobile body indicated by the situation information is less than a threshold value.

(9) The mobile body control method according to any one of (1) to (8), in which

the stop continuation determination step includes

determining to continue stopping at the first stop position in a case where the situation information indicates that another mobile body other than the mobile body on which a type of the subject that is highly likely to be used together with a type of the subject loaded on the mobile body is loaded is present within a predetermined distance.

(10) The mobile body control method according to any one of (1) to (9), in which

the stop continuation determination step includes

determining to continue stopping at the first stop position in a case where the situation information indicates that the first stop position is in a region having a high sales effect.

(11) The mobile body control method according to any one of (1) to (10), in which

the stop continuation determination step includes

determining to continue stopping at the first stop position in a case where the situation information indicates at least one of a first stop history involving stopping in a region within a predetermined distance from the first stop position a predetermined number of times or more according to detection of the purchase intention, and a second stop history involving stopping in the region a predetermined number of times or more within a predetermined period according to detection of the purchase intention.

(12) The mobile body control method according to any one of (1) to (11), in which

the stop continuation determination step includes

determining to continue stopping at the first stop position in a case where at least one of weather, air temperature, a stopping place, and a stopping time zone indicated by the situation information satisfies a predetermined condition.

(13) The mobile body control method according to any one of (1) to (12), in which

the stop continuation determination step includes

determining to continue stopping at the first stop position in a case where a change in a situation around the mobile body from a stop at the first stop position to an end of the selling operation indicated by the situation information is equal to or greater than a threshold value.

(14) The mobile body control method according to any one of (1) to (13), in which

the movement control step includes

in a case where purchase intention of a second user other than the first user is detected in the detection step and a second stop position is specified in the specification step during movement of the mobile body to the first stop position, moving the mobile body to the second stop position and stopping it in a case where a distance to the first stop position is greater than or equal to a predetermined distance.

(15) A mobile body configured to autonomously move and sell a subject, the mobile body including:

a specification unit configured to specify a first stop position;

a movement control unit configured to control a drive unit of the mobile body so as to stop the mobile body at the first stop position;

an operation execution unit configured to cause a selling operation unit of the mobile body to execute a selling operation related to selling of the subject to a first user when the mobile body stops at the first stop position;

a stop continuation determination unit configure to determine whether to continue stopping at the first stop position based on situation information about the mobile body at an end of the selling operation; and

a stop continuation control unit configured to control the drive unit to continue stopping at the first stop position when it is determined that the stop is to be continued.

(16) A mobile body controlling computer program executed by a computer configured to control a mobile body configured to autonomously move and sell a subject, the mobile body controlling computer program including

a specification step of specifying a first stop position for stopping the mobile body;

a movement control step of stopping the mobile body at the first stop position;

an operation execution step of executing a selling operation related to selling of the subject to a first user when stopping at the first stop position;

a stop continuation determination step of determining whether to continue stopping at the first stop position based on situation information about the mobile body at an end of the selling operation; and

a stop continuation control step of performing control to continue stopping at the first stop position when determining to continue stopping.

(17) A management device including a control unit configured to manage a mobile body configured to autonomously move and sell a subject, the mobile body including

a specification unit configured to specify a first stop position,

a movement control unit configured to control a drive unit of the mobile body so as to stop the mobile body at the first stop position,

an operation execution unit configured to cause a selling operation unit of the mobile body to execute a selling operation related to selling of the subject to a first user when the mobile body stops at the first stop position,

a stop continuation determination unit configured to determine whether to continue stopping at the first stop position based on situation information about the mobile body at an end of the selling operation, and

a stop continuation control unit configured to control the drive unit to continue stopping at the first stop position when it is determined that the stop is to be continued, and

the control unit is configured to transmit the situation information to the mobile body.

What is claimed is:

1. A mobile body control method executed by a computer configured to control a mobile body configured to autonomously move and sell a subject, the mobile body control method comprising:
specifying a first stop position for stopping the mobile body;
stopping the mobile body at the first stop position;
executing a selling operation related to selling of the subject to a first user when stopping at the first stop position;
determining whether to continue stopping at the first stop position based on situation information about the mobile body at an end of the selling operation; and
performing control to continue stopping at the first stop position when determining to continue stopping.

2. The mobile body control method according to claim 1, further comprising:
detecting purchase intention of the first user, wherein
the specifying comprises
specifying a stoppable position around the first user as the first stop position when detecting the purchase intention.

3. The mobile body control method according to claim 1, wherein
the determining comprises
determining whether to continue stopping at the first stop position in accordance with the situation information indicating a presence situation of a second user other than the first user present around the mobile body.

4. The mobile body control method according to claim 1, wherein
the determining comprises
determining to continue stopping at the first stop position in a case where an attribute of a second user other than the first user present around the mobile body indicated by the situation information comprises at least one of a sales promotion target and a sales eligible target of the subject loaded on the mobile body.

5. The mobile body control method according to claim 1, wherein
the determining comprises
determining to continue stopping at the first stop position in a case where the subject purchased by the first user indicated by the situation information is a predetermined subject having an advertising effect for a second user other than the first user around the mobile body.

6. The mobile body control method according to claim 1, wherein
the determining comprises
determining to continue stopping at the first stop position in a case where at least one of a number of the subjects purchased by the first user and a purchase amount of the subject that is indicated by the situation information is greater than or equal to a predetermined value.

7. The mobile body control method according to claim 1, wherein
the determining comprises
determining to continue stopping at the first stop position in a case where the situation information indicates that another mobile body other than the mobile body in which at least some types of the subjects overlap is not present within a predetermined distance of the mobile body.

8. The mobile body control method according to claim 1, wherein
the determining comprises
determining to continue stopping at the first stop position in a case where a total number of other mobile bodies other than the mobile body present within a predetermined range including the first stop position of the mobile body indicated by the situation information is less than a threshold value.

9. The mobile body control method according to claim 1, wherein
the determining comprises
determining to continue stopping at the first stop position in a case where the situation information indicates that another mobile body other than the mobile body on which a type of the subject that is highly likely to be used together with a type of the subject loaded on the mobile body is loaded is present within a predetermined distance.

10. The mobile body control method according to claim 1, wherein
the determining comprises
determining to continue stopping at the first stop position in a case where the situation information indicates that the first stop position is in a region having a high sales effect.

11. The mobile body control method according to claim 2, wherein
the determining comprises
determining to continue stopping at the first stop position in a case where the situation information indicates at least one of a first stop history involving stopping in a region within a predetermined distance from the first stop position a predetermined number of times or more according to detection of the purchase intention, and a second stop history involving stopping in the region a predetermined number of times or more within a predetermined period according to detection of the purchase intention.

12. The mobile body control method according to claim 1, wherein
the determining comprises
determining to continue stopping at the first stop position in a case where at least one of weather, air temperature, a stopping place, and a stopping time zone indicated by the situation information satisfies a predetermined condition.

13. The mobile body control method according to claim 1, wherein
the determining comprises
determining to continue stopping at the first stop position in a case where a change in a situation around the mobile body from a stop at the first stop position to an end of the selling operation indicated by the situation information is equal to or greater than a threshold value.

14. The mobile body control method according to claim 2, further comprising
when detecting purchase intention of a second user other than the first user and specifying a second stop position during movement of the mobile body to the first stop position, moving the mobile body to the second stop position and stopping it in a case where a distance to the first stop position is greater than or equal to a predetermined distance.

15. A mobile body configured to autonomously move and sell a subject, the mobile body comprising:
a memory; and
a hardware processor coupled to the memory and configured to:
specify a first stop position;
control a driver of the mobile body so as to stop the mobile body at the first stop position;
execute a selling operation related to selling of the subject to a first user when the mobile body stops at the first stop position;
determine whether to continue stopping at the first stop position based on situation information about the mobile body at an end of the selling operation; and
control the driver to continue stopping at the first stop position when determining to continue stopping.

16. A computer program product including programmed instructions embodied in and stored on a non-transitory computer readable medium, wherein the instructions, when executed by a computer configured to control a mobile body configured to autonomously move and sell a subject, cause the computer to perform:
specifying a first stop position for stopping the mobile body;
stopping the mobile body at the first stop position;
executing a selling operation related to selling of the subject to a first user when stopping at the first stop position;
determining whether to continue stopping at the first stop position based on situation information about the mobile body at an end of the selling operation; and
performing control to continue stopping at the first stop position when determining to continue stopping.
